(19) United States
(12) Patent Application Publication
(10) Pub. No.: US 2023/0370233 A1
(43) Pub. Date: Nov. 16, 2023

(54) PROBABILITY INDICATION FOR INTERFERENCE MANAGEMENT

(71) Applicant: QUALCOMM Incorporated, San Diego, CA (US)

(72) Inventors: Qian ZHANG, Basking Ridge, NJ (US); Yan ZHOU, San Diego, CA (US); Junyi LI, Fairless Hills, PA (US); Navid ABEDINI, Basking Ridge, NJ (US); Tao LUO, San Diego, CA (US)

(21) Appl. No.: 17/663,415

(22) Filed: May 13, 2022

(51) Int. Cl. H04L 5/00; H04B 7/0408

(52) U.S. Cl. CPC H04L 5/006; H04B 7/0408; H04L 5/0035; H04L 5/0048

(57) ABSTRACT

A first network node may identify at least one of a usage probability or an interference probability of each Rx beam of the first network node in a plurality of Tx-Rx beam pairs associated with the first network node and the second network node. The usage probability may include a usage metric that indicates a likelihood of using a beam. The interference probability may include an interference metric that indicates a likelihood of a Tx beam of the second network node interfering with an Rx beam of the first network node. The first network node may transmit a first indication of the usage probability or the interference probability of each Rx beam in the plurality of Tx-Rx beam pairs. The second network node may receive the first indication and adjust a beam schedule for at least one of the plurality of Tx-Rx beam pairs based on the received first indication.

### TECHNICAL FIELD

The present disclosure relates generally to communication systems, and more particularly, to a scheduling system to minimize interference between wireless transmissions.

### INTRODUCTION

Wireless communication systems are widely deployed to provide various telecommunication services such as telephony, video, data, messaging, and broadcasts. Some wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is not intended to either identify key elements or critical elements of all aspects nor intended to delineate the scope of any or all aspects. Its sole purpose is to present some concepts of one or more aspects in a simplified form as a prelude to the more detailed description that is presented later.

When a network node receives a first transmission at the same time as another network node transmits a second transmission, the first and second transmissions may interfere with one another. For example, a first transmission sent from a first network node to a second network node may interfere with a second transmission sent from a third network node to a fourth network node. Such situations may occur more often when network nodes are capable of full duplex (FD) simultaneous uplink/downlink transmission. For example, a first transmission sent from a first network node to a second network node may interfere with a second transmission sent from a third network node to the first network node. Such interference may occur whenever any portion of a transmit (Tx) beam is sent during a time period that overlaps with a time period in which a receive (Rx) beam is received. For example, such interference may occur between a base station (BS) Tx beam and a BS Rx beam, between a BS Tx beam and a user equipment (UE) Rx beam, between a UE Tx beam and a BS Rx beam, or between a UE Tx beam and a UE Rx beam.

A first network node may identify at least one of a usage probability or an interference probability of each Rx beam of the first network node in a plurality of Tx-Rx beam pairs associated with the first network node and the second network node. The usage probability may include a usage metric that indicates a likelihood of using a beam. The interference probability may include an interference metric that indicates a likelihood of a Tx beam of the second network node interfering with an Rx beam of the first network node. The first network node may transmit a first indication of the usage probability or the interference probability of each Rx beam in the plurality of Tx-Rx beam pairs. The second network node may receive the first indication and adjust a beam schedule for at least one of the plurality of Tx-Rx beam pairs based on the received first indication.

In an aspect of the disclosure, a method, a computer-readable medium, and an apparatus are provided. The apparatus may have a memory and at least one processor coupled to the memory and configured to identify at least one of a usage probability or an interference probability of each Rx beam of the first network node in a plurality of Tx-Rx beam pairs associated with the first network node and a second network node. The usage probability may include a usage metric that indicates a likelihood of using a beam. The interference probability may include an interference metric that indicates a likelihood of a Tx beam of the second network node interfering with an Rx beam of the first network node. The at least one processor may be further configured to transmit, to the second network node, a first indication of at least one of the usage probability or the interference probability of each Rx beam in the plurality of Tx-Rx beam pairs.

In another aspect of the disclosure, a method, a computer-readable medium, and an apparatus are provided. The apparatus may have a memory and at least one processor coupled to the memory and configured to receive, from a second network node, a first indication of at least one of a usage probability or an interference probability of each Rx beam of the second network node in a plurality of Tx-Rx beam pairs. The usage probability may include a usage metric that indicates a likelihood of using a beam. The interference probability may include an interference metric that indicates a likelihood of a Tx beam of the first network node interfering with an Rx beam of the second network node. The at least one processor may be further configured to adjust a beam schedule for at least one of the plurality of Tx-Rx beam pairs based on the received first indication.

To the accomplishment of the foregoing and related ends, the one or more aspects may include the features hereinafter fully described and particularly pointed out in the claims. The following description and the annexed drawings set forth in detail certain illustrative features of the one or more aspects. These features may be indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station (BS) and user equipment (UE) in an access network.

FIG. 4 is a network connection flow diagram that illustrates an example of two BS devices that may have an Rx beam and a Tx beam, respectively, that may interfere with one another.

FIG. 5 is a network connection flow diagram that illustrates an example of another two BS devices that may have an Rx beam and a Tx beam, respectively, that may interfere with one another.

FIG. 6 is a network connection flow diagram that illustrates an example of a UE and a BS that may have an Rx beam and a Tx beam, respectively, that may interfere with one another.

FIG. 7 is a network connection flow diagram that illustrates another example of a UE and a BS that may have an Rx beam and a Tx beam, respectively, that may interfere with one another.

FIG. 8 is a network connection flow diagram that illustrates an example of a UE and a UE that may have an Rx beam and a Tx beam, respectively, that may interfere with one another.

FIG. 9 is a network connection flow diagram that illustrates another example of a UE and a UE that may have an Rx beam and a Tx beam, respectively, that may interfere with one another.

FIG. 10 is a network connection flow diagram that illustrates an example of a BS and a UE that may have an Rx beam and a Tx beam, respectively, that may interfere with one another.

FIG. 11 is a network connection flow diagram that illustrates another example of a BS and a UE that may have an Rx beam and a Tx beam, respectively, that may interfere with one another.

FIG. 12 is a network connection flow diagram that illustrates an example of a UE and a UE that may have an Rx beam and a Tx beam, respectively, that may interfere with one another.

FIG. 13 is a network connection flow diagram that illustrates another example of a UE and a UE that may have an Rx beam and a Tx beam, respectively, that may interfere with one another.

FIG. 14 is a flowchart of a method of wireless communication at a wireless device, in accordance with various aspects of the present disclosure.

FIG. 15 is a flowchart of another method of wireless communication at a wireless device, in accordance with various aspects of the present disclosure.

FIG. 16 is a flowchart of another method of wireless communication at a wireless device, in accordance with various aspects of the present disclosure.

FIG. 17 is a flowchart of another method of wireless communication at a wireless device, in accordance with various aspects of the present disclosure.

FIG. 18 is a diagram illustrating an example of a hardware implementation for an example apparatus.

FIG. 19 is a diagram illustrating another example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

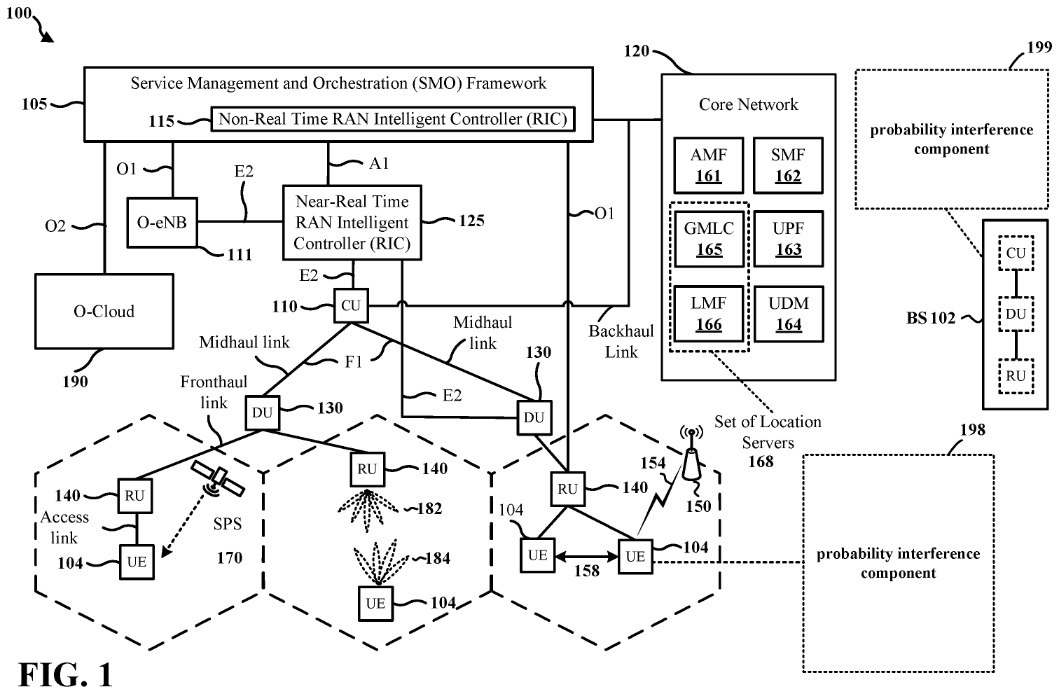

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a UE 104 may have a probability interface component 198 configured to determine a usage probability and/or an interference probability of a beam of a Tx-Rx pair and/or adjust a beam schedule to minimize the probability of interference. In certain aspects, a base station (BS) 102 may similarly have a probability interface component 199 configured to determine a usage probability and/or an interference probability of a beam of a Tx-Rx pair and/or adjust a beam schedule to minimize the probability of interference. The BS 102 may transmit a Tx beam, which may interfere with an Rx beam received by the BS 102, by another BS, or by another UE. The Tx beam may be received by yet another BS or by yet another UE. The Rx beam may be transmitted by yet another BS or by yet another UE. The UE 104 may transmit a Tx beam, which may interfere with an Rx beam received by the BS 102, by another BS, or by another UE. The Tx beam may be received by yet another BS or by yet another UE. The Rx beam may be transmitted by yet another BS or by yet another UE.

One or more probability interface components, such as the probability interface component 198 of the UE 104 or the probability interface component 199 of the BS 102, may be configured to determine a usage probability and/or an interference probability of a beam of a Tx-Rx pair and adjust a beam schedule to minimize interference. When a usage probability or an interference probability reaches, or is over, a threshold, a probability interface component may adjust a beam schedule and implement the schedule on a suitable wireless device, such as the wireless device transmitting the Tx beam, the wireless device receiving the Rx beam, or a wireless device scheduling the Tx beam or the Rx beam. Although the following description may be focused on 5G NR, the concepts described herein may be applicable to other similar areas, such as LTE, LTE-A, CDMA, GSM, and other wireless technologies. Each of the UE 104 of the BS 102 may be referred to as a wireless device or a network node.

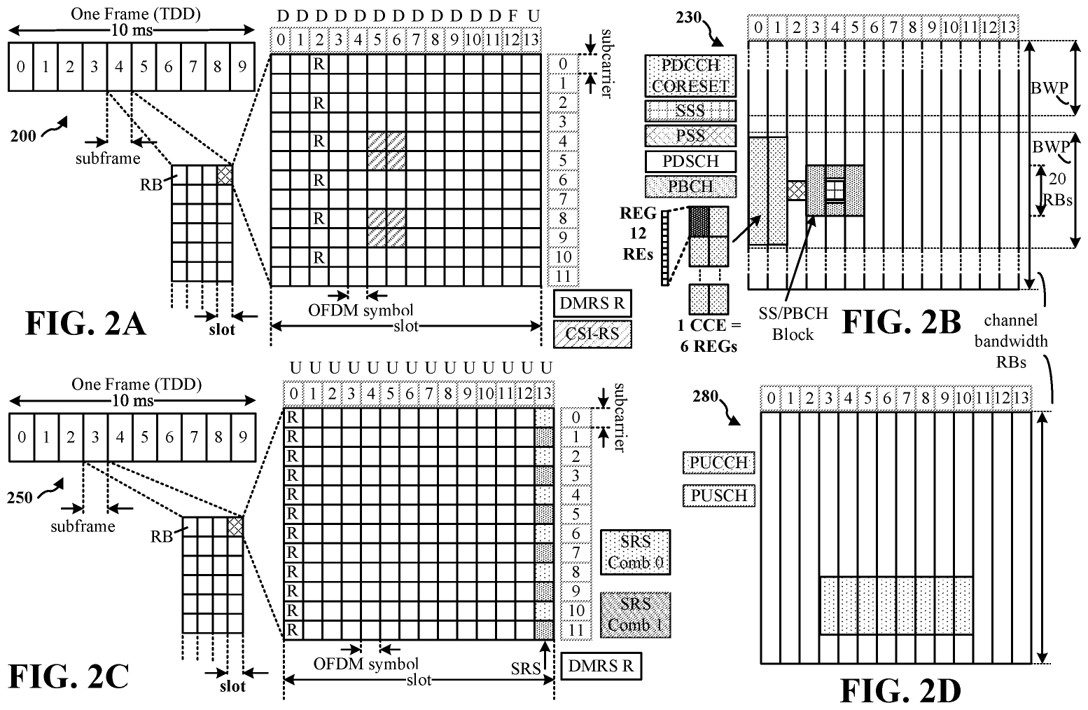

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

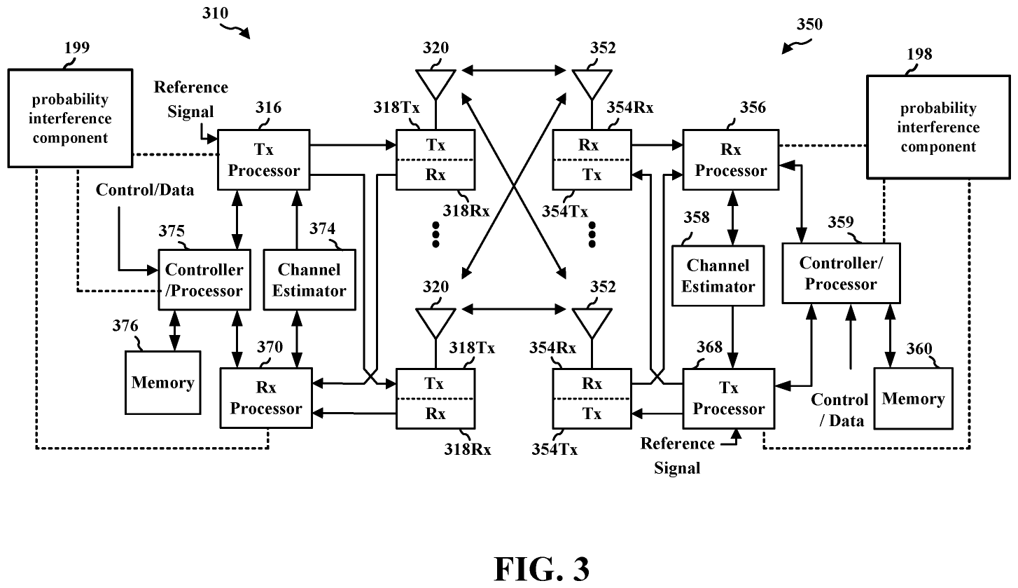

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the probability interface component 198 in FIG. 1.

At least one of the Tx processor 316, the Rx processor 370, and the controller/processor 375 may be configured to perform aspects in connection with the probability interface component 199 in FIG. 1.

Network nodes (a.k.a. wireless devices), such as a BS and/or a UE, may be configured to have FD capability. That is, such wireless devices may be configured to simultaneously transmit a Tx beam and receive an Rx beam. Such devices may be configured to perform simultaneous UL/DL transmission using any suitable band, for example bands in frequency range 1 (FR1), frequency range 2 (FR2), frequency range 4 (FR4), and frequency range 5 (FR5). Different associated aspects of procedures may also perform similar functionality. FD capability may be configured for a BS, a UE, or both. For example, a UE may be configured to perform an UL transmission using one panel and a DL reception using another panel. Further, a BS may be configured to receive an UL beam using one panel and transmit a DL beam using another panel. FD capability may be conditional on a wireless device having one or more hardware and/or software configurations, such as having two different antennas or using beam separation. A single wireless device's UL/DL beams may even interfere with one another, causing self-interference between the UL and DL beams for the same device, or clutter echo (e.g., caused by direct leakage from a transmitter to a receptor, or caused by a reflector that reflects a signal back to a reception panel).

Configuring devices to have FD capability may provide many benefits, such as latency reduction. It may be possible to receive a DL signal in UL-only slots, which may enable latency savings. FD capability may also enhance spectrum efficiency (SE) for each cell, or for each UE, configured to have FD capability. By configuring a device to simultaneously handle both UL and DL transmission, resources may be utilized more efficiently, and coverage for devices may be enhanced.

A plurality of simultaneous UL/DL transmission scenarios may be enabled by a BS or a UE that is configured for FD capability. For example, the UE 104 in FIG. 1 may be configured to simultaneously receive a DL transmission from the BS 102 and transmit an UL transmission to another BS. Additionally, or alternatively, the UE 104 may be configured to transmit an UL transmission to the BS 102 while another UE 104 receives a DL transmission from the same BS 102. Additionally, or alternatively, the UE 104 may be configured to simultaneously transmit an UL transmission and receive a DL transmission from the same BS 102. Additionally, or alternatively, the UE 104 may be configured to simultaneously transmit a sidelink transmission to another UE 104 while receiving another sidelink transmission from the same UE. Additionally, or alternatively, the UE 104 may be configured to simultaneously transmit a sidelink transmission to another UE 104 while receiving another sidelink transmission from yet another UE.

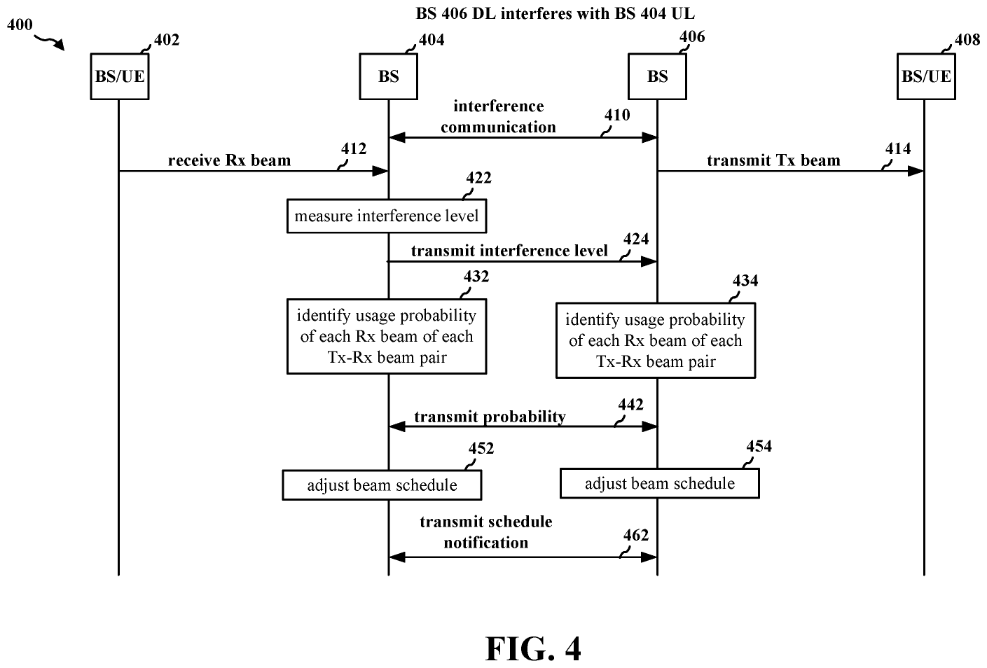

However, with additional transmissions comes an increased risk of transmissions interfering with one another. For example, FIG. 4 shows a network connection flow diagram 400 that illustrates an example of BS 404 and BS 406 that may have a Tx beam 414 that may interfere with an Rx beam 412. The network connection flow diagram 400 has a wireless device 402, which may be a BS or a UE, a BS 404, a BS 406, and another wireless device 408, which may also be a BS or a UE. When the BS 406 transmits a Tx beam 414 to the wireless device 408, the Tx beam 414 may interfere with an Rx beam 412 transmitted from the wireless device 402 to the BS 404. The network connection flow diagram 400 illustrates a use case for inter-gNB, or inter-BS, cross link interference (CLI) where usage probability information of a gNB/BS beam may be transmitted via inter-gNB, or inter-BS, messaging to decrease potential interference between Tx-Rx beams.

To determine what possible Tx beams from BS 406 may interfere with an Rx beam sent to BS 404, BS 406 may be configured to communicate with BS 404 using an interference communication 410. For example, the BS 406 may transmit a list of Tx beams that the BS 406 is capable of transmitting to the BS 404, the BS 404 may transmit a list of Rx beams that the BS 404 is capable of receiving to the BS 406, the BS 404 may transmit a Tx-Rx matrix of known interference levels to the BS 406 which may be used by the BS 406 to determine which Tx beams may interfere with Rx beams of BS 404, or the BS 404 may transmit a Tx-Rx matrix of known interference probabilities to the BS 406 which may be used by the BS 406 to determine which Tx beams may have a high probability of creating an interference with Rx beams of BS 404. The BS 404 and the BS 406 may also use interference communication 410 signals to configure a series of tests for BS 406 to transmit one or more measurement RS Tx beams 414 while BS 404 receives an Rx beam 412 to determine which Tx beams 414 may interfere with Rx beams 412 of BS 404, and to what extent.

In other words, for inter-gNB, or inter-BS, interference measurements, a measurement RS may be sent from an aggressor gNB (e.g., BS 406) while a victim gNB (e.g., BS 404) receives a transmission to measure actual interference. For example, a BS 406 may be configured to transmit a measurement RS for each possible Tx-Rx beam pair between a BS 406 and a BS 404, respectively. For each Tx-Rx beam pair, the BS 404 may be configured to measure 422 an interference level to determine what Tx beams may interfere with Rx beams sent to the BS 404, and/or to what extent. An interference level may be measured in a plurality of ways, for example a percentage of a received Rx beam that is inaccurate, a number of inaccurate data sets per time window (e.g., bits per second or bytes per minute), a Boolean value measurement that indicates whether or not an incoming Rx beam transmission has failed based on a measurable metric, a number of incoming packets that failed within a period of time, or a number of sub-time windows within a larger time window when a received Rx beam has over a threshold number of inaccuracies (e.g., for 16 seconds per minute, a received Rx beam had over 10% inaccurate bits). The BS 404 may transmit 424 at least some of the measurement results to the BS 406.

The measurement results may be used to populate or update values for a Tx-Rx matrix that indicates interference levels for each Tx-Rx combination (e.g., a Tx of beam #1 and an Rx of beam #1, a Tx of beam #1 and an Rx of beam #2, a Tx of beam #1 and an Rx of beam #3). A beam may be categorized as a frequency band or a set of channels, such as a band as labeled in FR1 or FR2 (e.g., n1, n74). As an example, a victim BS, such as the BS 404, may indicate to the aggressor BS, such as the BS 406, the forbidden usage of a high interference DL beam (i.e., Tx beam of aggressor gNB, or Tx beam 414) to protect the victim BS's RRC U symbol. Additionally, or alternatively, a BS may indicate to a neighbor BS a usage probability of each DL/UL beam at the BS. In other words, a victim BS may indicate the usage probability of each UL beam and the aggressor BS may indicate the usage probability of each DL beam, which may be used in semi-static Tx/Rx occasions or during a future time window. A usage probability may be a metric that indicates the likelihood that a wireless device will use a beam. The likelihood may be expressed in a plurality of ways, for example as a likelihood within a time window (e.g., 60% of the time in a five-minute time window) or as a percentage of total beams used (e.g., 60% of all beams used).

For example, a usage probability of BS 406 transmitting a Tx beam #1 may be 50% whereas a usage probability of a BS 404 receiving an Rx beam #2 may be 80%. A usage probability may be calculated by, for example, analyzing a totality of beams transmitted and/or received by a wireless device within a time window, e.g., an hour, a day, a week, or a month. A usage probability may be measured as a metric of how many of a type of beam is transmitted or received within a time window, or how many of a type of beam is transmitted or received out of a number of beam packets transmitted or received. A usage probability may be tracked by a wireless device, such as a UE or a BS, and may be saved to a memory accessible by the wireless device. Such a wireless device may be configured to dynamically update a usage probability of various beams periodically, such as every day or every week. A usage probability may also be calculated as a function of a time window, e.g., every Monday between 5:00 AM-6:00 AM, every federal holiday, or during every yearly special event. A device may identify or save usage probabilities that are associated with a threshold, such as usage probabilities that exceed a usage threshold (e.g., over 30% of a time window), usage probabilities that are less than a usage threshold (e.g., less than 90% of a time window) or usage probabilities that are between two thresholds (e.g., less than 90% of a time window and over 30% of a time window).

The BS 404 may identify 432 a usage probability for each Rx beam of each Tx-Rx beam pair. Additionally, or alternatively, the BS 404 may identify 432 a usage probability for each Rx beam of each Tx-Rx beam pair where the Rx beam has a measured interference level that meets or exceeds a minimum threshold, such as 10% or more than 100 bytes per minute or more than 15% of a time window. Alternatively, or additionally, the BS 406 may identify 434 a usage probability for each Tx beam of each Tx-Rx beam pair. Alternatively, or additionally, the BS 406 may identify 434 a usage probability for each Tx beam of each Tx-Rx beam pair where the Tx beam has caused a measured interference level for at least one Rx beam, where the measured interference level meets or exceeds a minimum threshold. The BS 404 may transmit 442 the usage probability of each Rx beam of each Tx-Rx beam pair to the BS 406, and/or the BS 406 may transmit 442 the usage probability of each Tx beam of each Tx-Rx beam pair to the BS 404.

If the usage probability of using a particular beam is high in a time window, a neighbor gNB or BS may be configured to avoid using a non-compatible or high interference beam in the reverse diction on the resources, or by a negotiation between gNBs or B Ss. For example, with the usage probability information, the BS 406 may be able to adjust 454 a beam schedule for a Tx beam 414 of the BS 406 or an Rx beam 412 of the BS 404. In an aspect, a victim gNB may indicate that a usage probability of UL beam #2 is 80% in a time window, an aggressor gNB may be configured to avoid using a non-compatible DL beam #1 which may cause a high interference to UL beam #2 in the reverse direction on the victim gNB's RRC U symbols. In other words, with regard to network connection flow diagram 400, the BS 404 may transmit 442 a usage probability to BS 406 that a usage probability of an UL Rx beam 412 is 80% in a time window. The BS 406 may then adjust 454 a beam schedule of a non-compatible DL Tx beam 414 to the UL Rx beam 412 to avoid interfering with the high probability UL Rx beam 412. In another example, a victim gNB may indicate to an aggressor gNB that a usage probability of UL beam #2 is 80% in a time window, and the aggressor gNB may transmit a schedule notification or a signaling of a recommendation to the victim gNB to reduce UL beam #2 usage probability so that its DL beam #1 for URLLC traffic may be scheduled. In other words, with regard to network connection flow diagram 400, the BS 404 may transmit 442 a usage probability to BS 406 that a usage probability of an UL Rx beam 412 is 80% in a time window. The BS 406 may be configured to recognize that it will be transmitting a non-compatible DL Tx beam 414 during that same time window, and may adjust 454 a beam schedule of the BS 404 and transmit 462 a schedule notification or a signaling of a recommendation to the BS 404 to reduce the usage probability for the non-compatible UL Rx beam 412.

A threshold of usage probability may be configured from a control unit (CU) such that a gNB or BS may be configured to reduce the likelihood of an interference when a usage probability meets or exceeds a usage threshold. For example, the BS 406 may transmit 442 an increased usage probability value for the BS 406 to use a Tx beam 414 that interferes with the Rx beam 412. In response, the BS 404 may be configured to recognize that the increased usage probability value exceeds a usage threshold, and, in response, may adjust 452 a beam schedule to use an Rx beam 412 that is not susceptible to interference by the Tx beam 414. Alternatively, the BS 404 may be configured to, in response to determining that the increased usage probability value exceeds a usage threshold, transmit 462 a schedule notification to the BS 406 to reduce the usage probability of a Tx beam 414 that interferes with the Rx beam 412. Such configurations may enable a BS 404 and/or a BS 406 to adjust 452, 454, respectively, a beam schedule to avoid using a non-compatible or high interference beam in a reverse direction on such resources in response to determining that a usage probability meets or exceeds a usage threshold.

The BS 404 or the BS 406, or both the BS 404 and the BS 406, may be configured to adjust 452, 454, a beam schedule to minimize a probability of interference based upon the measured interference levels for each Tx-Rx beam pair and the usage probability of the Rx beam, the usage probability of the Tx beam, or the usage probability of both beams of the Tx-Rx beam pairs. For example, the BS 404 may be configured to avoid scheduling a conflicting Rx beam during time windows when the BS 406 is known to have a high usage probability (e.g., a usage probability that meets or exceeds a usage threshold) of one or more Tx beams that interferes with that Rx beam. Additionally, or alternatively, the BS 404 may be configured to transmit 462 a schedule notification to the BS 406 to avoid transmitting one or more conflicting Tx beams during time windows when the BS 404 has a high usage probability to receive a conflicting Rx beam. Additionally, or alternatively, the BS 406 may be configured to avoid scheduling one or more conflicting Tx beams during time windows when the BS 404 may have a high usage probability for an Rx that is interfered with by the one or more conflicting Tx beams. Additionally, or alternatively, the BS 406 may be configured to transmit 462 a schedule notification to the BS 404 to avoid transmitting one or more conflicting Rx beams during time windows when the BS 406 may have a high usage probability for a Tx that interferes with the one or more conflicting Rx beams. Adjusting a usage probability for a beam downwards may mean not using the beam at all (e.g., 0%), which may be suitable in situations where a usage probability for a conflicting beam is at or near 100%. Adjusting a usage probability for a beam upwards may mean using the beam during an entire time period (e.g., 100%), which may be suitable in situations where there is no measured interference between that beam and any other beam having a non-zero usage probability in a Tx-Rx matrix of measured interference levels.

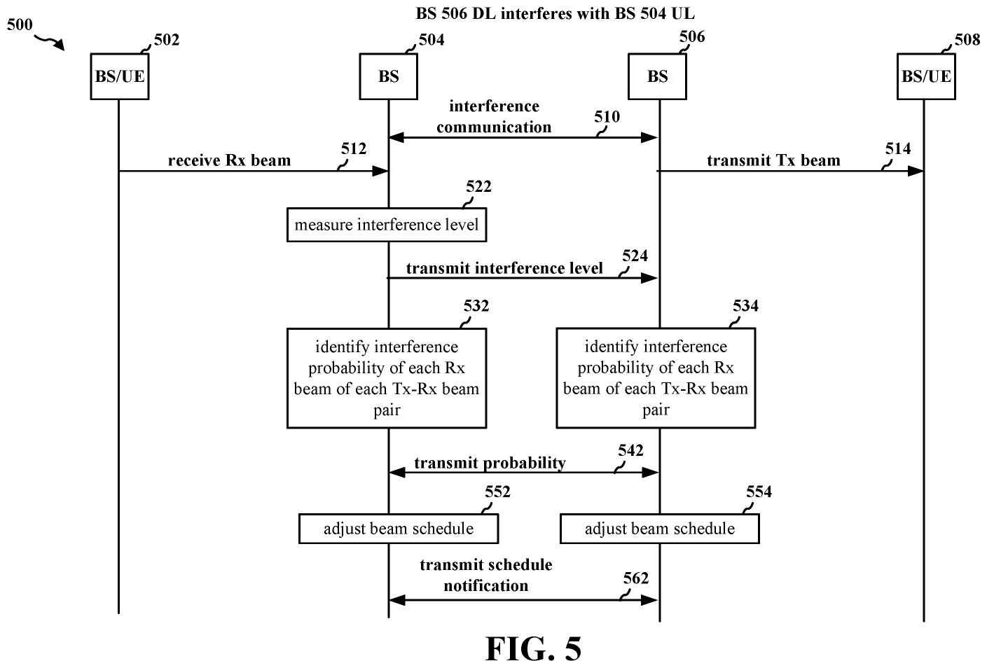

FIG. 5 shows a network connection flow diagram 500 that illustrates an example of BS 504 and BS 506 that may have a Tx beam 514 that may interfere with an Rx beam 512. The network connection flow diagram 500 has a wireless device 502, which may be a BS or a UE, a BS 504, a BS 506, and another wireless device 508, which may also be a BS or a UE. Similar to FIG. 4, when the BS 506 transmits a Tx beam 514 to the wireless device 508, the Tx beam 514 may interfere with an Rx beam 512 transmitted from the wireless device 502 to the BS 504. The network connection flow diagram 500 illustrates a use case for inter-gNB, or inter-BS, CLI where interference probability information of a gNB/BS beam may be transmitted via inter-gNB, or inter-BS, messaging to decrease potential interference between Tx-Rx beams.

To determine what possible Tx beams from BS 506 may interfere with an Rx beam sent to BS 504, BS 506 may be configured to communicate with BS 504 using an interference communication 510 to determine what Tx beams from BS 506 may interfere with Rx beams sent to BS 504. For example, the BS 506 may transmit a list of Tx beams that the BS 506 is capable of transmitting to the BS 504, the BS 504 may transmit a list of Rx beams that the BS 504 is capable of receiving to the BS 506, the BS 504 may transmit a Tx-Rx matrix of known interference levels to the BS 506 such that BS 506 knows what Tx beams may interfere with Rx beams of BS 504, or the BS 504 may transmit a Tx-Rx matrix of known interference probabilities to the BS 506 such that BS 506 knows what Tx beams have a high probability of creating an interference with Rx beams of BS 504. The BS 504 and the BS 506 may also use interference communication 510 signals to configure a series of tests for BS 506 to transmit one or more measurement RS Tx beams 514 while BS 504 receives an Rx beam 512 to determine which Tx beams 514 may interfere with Rx beams 512 of BS 504, and to what extent.

In other words, for inter-gNB, or inter-BS, interference measurements, a measurement RS may be sent from an aggressor gNB (e.g., BS 506) while a victim gNB (e.g., BS 504) receives a transmission to measure actual interference. For example, a BS 406 may be configured to transmit a measurement RS for each possible Tx-Rx beam pair between a BS 406 and a BS 404, respectively. For each Tx-Rx beam pair, the BS 504 may be configured to measure 522 an interference level to determine what Tx beams may interfere with Rx beams sent to the BS 504 and/or to what extent. An interference level may be measured in a plurality of ways, for example a percentage of a received Rx beam that is inaccurate, a number of inaccurate data sets per time window (e.g., bits per second or bytes per minute), a Boolean value measurement that indicates whether or not an incoming Rx beam transmission has failed based on a measurable metric, a number of incoming packets that failed within a period of time, or a number of sub-time windows within a larger time window when a received Rx beam has over a threshold number of inaccuracies (e.g., for 16 seconds per minute, a received Rx beam had over 10% inaccurate bits). The BS 504 may transmit 524 at least some of the measurement results to the BS 506.

The measurement results may be used to populate or update values for a Tx-Rx matrix that indicates interference levels for each Tx-Rx combination. Additionally, or alternatively, a gNB or BS may indicate to a neighbor gNB or BS an interference probability of each DL/UL beam at the gNB or BS. For example, a victim gNB may be configured to indicate an interference probability that a DL beam from an aggressor gNB will interfere with an UL beam of the victim gNB, which may be used in a semi-static Tx/Rx occasion or during a future time window. An interference probability may be a metric that indicates the likelihood of a Tx beam interfering with an Rx beam. The likelihood may be expressed in a plurality of ways, for example as a likelihood within a time window (e.g., 60% of the time in a five-minute time window) or as a percentage of total beams used (e.g., 60% of all beams are interfered with).

For example, an interference probability of an Rx beam #1 received by BS 504 during a time window that a Tx beam #3 is being transmitted by BS 506 may be 50% whereas an interference probability of an Rx beam #3 received by BS 504 during a time window that a Tx beam #3 is being transmitted by BS 506 may be 80%. In another example, a victim gNB may indicate an UL beam is interfered by one or more aggressor gNB's DL beams at 80% of the time during a time window. An interference probability may be calculated in any suitable manner, for example as a function of a percentage of a time window (e.g., a Tx beam interfered with an Rx beam 50% of the time in a one-minute period) or as a function of a percentage of data units (e.g., a Tx beam interfered with 50% of the received packets of an Rx beam). A device may be configured to identify or save interference probabilities that are associated with a threshold. For example, interference probability values that meet or exceed an interference threshold (e.g., more than 50% of a time window), interference probability values that meet or are less than an interference threshold (e.g., less than 90% of a time window, or interference probability values that are between two thresholds (e.g., more than 50% of a time window and less than 90% of a time window). An interference probability may be determined by, for example, analyzing an Rx beam during a time period that a Tx beam is also transmitting, and calculating how many received packets within that time period failed, or how many transmitted bits within that time period were inaccurate. An interference probability may be saved as a probability specific to a wireless device that transmitted an RS Tx beam, specific to a wireless device that received an Rx beam, specific to a pair of wireless devices having a Tx beam and an Rx beam, respectively, specific to a type of any of the aforementioned wireless device, or may be saved as a probability specific to the type of beam (e.g., n81 or n258). A wireless device may be configured to dynamically update an interference probability of a Tx-Rx pair periodically, such as every day or every week, or in response to a trigger, such as when a location of the receiving wireless device or a transmitting wireless device moves by at least a threshold distance.

The BS 504 may identify 532 an interference probability for each Rx beam of each Tx-Rx beam pair. Additionally, or alternatively, the BS 504 may identify 532 an interference probability for each Rx beam of each Tx-Rx beam pair where the Rx beam has a measured interference level that meets or exceeds a minimum threshold, such as 10% or more than 100 bytes per minute or more than 15% of a time window. Alternatively, or additionally, the BS 506 may identify 534 an interference probability for each Tx beam of each Tx-Rx beam pair. Alternatively, or additionally, the BS 506 may identify 534 an interference probability for each Tx beam of each Tx-Rx beam pair where the Tx beam has caused a measured interference level that meets or exceeds a minimum threshold. The BS 504 may transmit 542 the interference probability of each Rx beam of each Tx-Rx beam pair to the BS 506, and/or the BS 506 may transmit 542 the interference probability of each Tx beam of each Tx-Rx beam pair to the BS 504. The BS 504 may generate a Tx-Rx matrix of interference probabilities for every Tx of the BS 506 that interferes with an Rx of the BS 504 with an interference level that meets or exceeds an interference level threshold.

If the interference probability of a particular beam is high in a time window (i.e., meets or exceeds an interference threshold), a neighbor gNB or BS may be configured to avoid using a non-compatible or high interference beam in the reverse diction on the resources, or by a negotiation between gNBs or BSs. For example, with the interference probability information, the BS 406 may be able to adjust 454 a beam schedule for a Tx beam 414 of the BS 406 or an Rx beam 412 of the BS 404. In an aspect, a neighbor aggressor gNB may be configured to avoid using such interfering DL beams in a reverse direction in a future time window. A victim gNB may indicate to an aggressor gNB an interference probability (e.g., an interference probability of 80%) during a time window when the victim gNB receives an UL beam #2 and the aggressor gNB transmits a DL beam #1. In response, the aggressor gNB may be configured to avoid using the non-compatible DL beam #1 which may be indicated to cause interference to UL beam #2 in the reverse direction on the victim gNB's RRC U symbols a certain amount of time (e.g., 80% of the time). In other words, with regard to network connection flow diagram 500, the BS 504 may transmit 532 an interference probability (e.g., an interference probability of 80%) to the BS 506 for an Rx beam 512 and Tx beam 514 pair. In response, the BS 506 may adjust 554 a beam schedule for the Tx beam 514 to not coincide with the reception of the Rx beam 512. Alternatively, the aggressor gNB may transmit a schedule notification or a signaling of a recommendation to the victim gNB to not receive data using UL beam #2, so that its DL beam #1 for URLLC traffic may be scheduled. In other words, with regard to network connection flow diagram 500, the BS 506 may adjust 554 a beam schedule of the BS 504 and transmit 562 a schedule notification or a signaling of a recommendation to the BS 504 to not use the non-compatible Rx beam 512 during a period of time so that the BS 506 may transmit its Tx beam 514 during that period of time without interfering with the non-compatible Rx beam 512.

A threshold of interference probability may be configured from a control unit (CU) so that a gNB or BS may be configured to trigger an action to reduce the likelihood of an interference when an interference probability meets or exceeds an interference threshold.

The BS 504 or the BS 506, or both the BS 504 and the BS 506, may be configured to adjust 552, 554, a beam schedule to minimize a probability of interference based upon the measured interference levels for each Tx-Rx beam pair and the interference probability of the Rx beam, the interference probability of the Tx beam, or the interference probability of both beams of the Tx-Rx beam pairs. For example, the BS 504 may be configured to avoid scheduling a conflicting Rx beam during time windows when the BS 506 is known to be transmitting a Tx that has a high interference probability of interfering with that conflicting Rx beam. Additionally, or alternatively, the BS 504 may be configured to transmit 562 a schedule notification to the BS 506 to avoid transmitting a conflicting Tx beam during time windows when the BS 504 is transmitting an Rx beam having a high interference probability with respect to the conflicting Tx beam. Additionally, or alternatively, the BS 506 may be configured to avoid scheduling a conflicting Tx beam during time windows when the BS 504 may be receiving data using an Rx beam that has a high interference probability with respect to the conflicting Tx beam. Additionally, or alternatively, the BS 506 may be configured to transmit 562 a schedule notification to the BS 504 to avoid transmitting a conflicting Rx beam during time windows when the BS 506 may be scheduled to transmit a Tx that has a high interference probability with respect to the conflicting Rx beam. Adjusting a usage probability for a beam downwards may mean not using the beam at all (e.g., 0% usage probability), which may be suitable in situations where an interference probability for a conflicting beam is at or near 100%. Adjusting a usage probability for a beam upwards may mean using the beam during an entire time period (e.g., 100% usage probability), which may be suitable in situations where there is no measured interference between that beam and any other beam in a Tx-Rx matrix of measured interference levels.

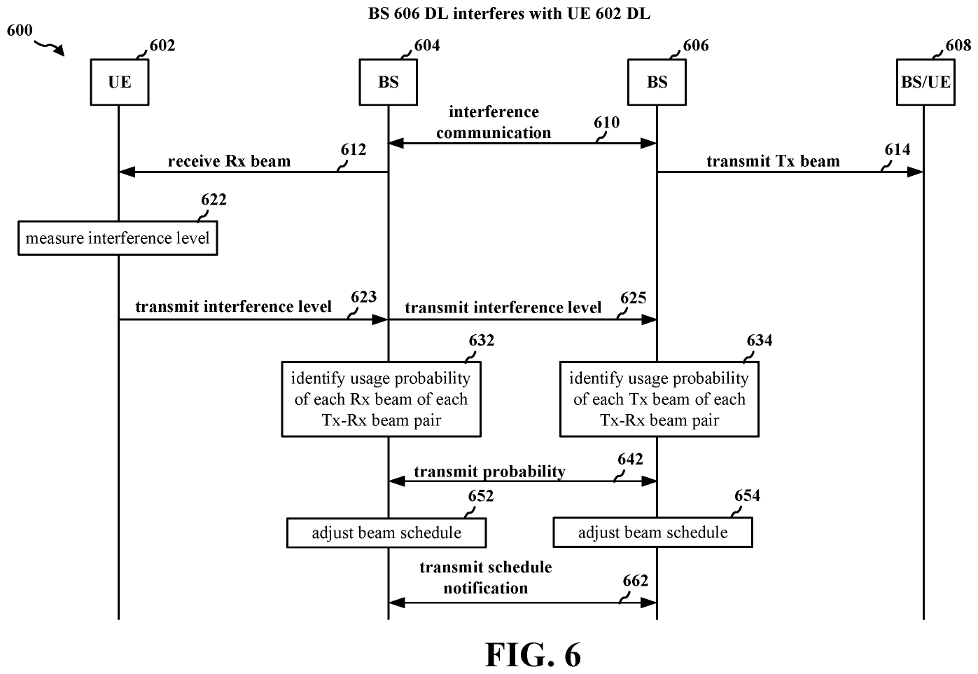

FIG. 6 shows a network connection flow diagram 600 that illustrates an example of a UE 602 and a BS 606 that may have a Tx beam 614 that may interfere with an Rx beam 612. The network connection flow diagram 600 has a UE 602, a BS 604, a BS 606, and a wireless device 608, which may be a BS or a UE. When the BS 606 transmits a Tx beam 614 to the wireless device 608, the Tx beam 614 may interfere with an Rx beam 612 transmitted from the BS 604 to the UE 602. The network connection flow diagram 600 illustrates a use case for a neighbor BS-to-serving UE interference where usage probability assistance information of a BS beam may be provided via inter-BS messaging to decrease potential interference between Tx-Rx beams.

To determine what possible Tx beams from BS 606 may interfere with an Rx beam sent to UE 602, BS 606 may be configured to communicate with BS 604 using an interference communication 610. For example, the BS 606 may transmit, to the BS 604, a list of Tx beams that the BS 606 is capable of transmitting to the wireless device 608. The BS 604 may transmit, to the BS 606, a list of Rx beams that the UE 602 is capable of receiving from the BS 604. The BS 604 may transmit, to the BS 606, a Tx-Rx matrix of known interference levels of UE 602 (or a device type similar to the device type of UE 602) such that BS 606 knows what Tx beams may interfere with Rx beams of UE 602. Also, the BS 604 may transmit, to the BS 606, a Tx-Rx matrix of known interference probabilities such that BS 606 knows what Tx beams have a high probability of creating an interference with Rx beams of UE 602 (or a device type similar to the device type of UE 602). The BS 604 and the BS 606 may also use interference communication 610 signals to configure a series of tests for BS 606 to transmit one or more measurement RS Tx beams 614 while UE 602 receives an Rx beam 612 to determine which Tx beams 614 may interfere with Rx beams 612 of UE 602, and to what extent.

While a measurement RS may be sent from an aggressor gNB to a victim UE to measure actual interference, similarly with regard to BS 404 and BS 406 in FIG. 4, a Tx-Rx matrix of known interference levels or known interference probabilities for a similar UE (e.g., a UE of the same make and model) may be used to estimate what Tx beams from BS 606 may interfere with Rx beams transmitted to UE 602. Additionally, or alternatively, a test UE 602 may be used to generate such a Tx-Rx matrix, which may be configured to analyze how much interference various Rx beams 612 may receive while various Tx beams 614 are transmitted from the BS 606. The BS 606 may be configured to transmit a measurement RS for each Tx for known Tx-Rx beam pairs between the BS 606 and the UE 602. For each Tx-Rx beam pair, the UE 602 may be configured to measure 622 an interference level to determine what Tx beams interfere with Rx beams sent to the UE 602. An interference level may be measured in a plurality of ways, for example a percentage of a received Rx beam that is inaccurate, a number of inaccurate data sets per time window (e.g., bits per second or bytes per minute), a Boolean value measurement that indicates whether or not an incoming Rx beam transmission has failed, how many incoming packets failed within a period of time, or a number of sub-time windows within a larger time window when a received Rx beam has over a threshold number of inaccuracies (e.g., for 16 seconds per minute, a received Rx beam had over 10% inaccurate bits). The UE 602 may transmit 623 at least some of the measurement results to the BS 604, which may transmit 625 at least some of the measurement results to the BS 606. The measurement results may be used to populate a Tx-Rx matrix that indicates interference levels for each Tx-Rx combination, as described above.

The BS 604 may identify 632 a usage probability for each Rx beam of each Tx-Rx beam pair. Additionally, or alternatively, the BS 604 may identify 632 a usage probability for each Rx beam of each Tx-Rx beam pair where the Rx beam had a measured interference level that meets or exceeds a threshold interference measurement, such as 10% or more than 100 bytes per minute or more than 15% of a time window. Alternatively, or additionally, the BS 606 may identify 634 a usage probability for each Tx beam of each Tx-Rx beam pair. Alternatively, or additionally, the BS 606 may identify 634 a usage probability for each Tx beam of each Tx-Rx beam pair where the Tx beam had caused a measured interference level that meets or exceeds a threshold interference measurement. The BS 604 may transmit 642 the usage probability of each Rx beam of known Tx-Rx beam pairs to the BS 606, and/or the BS 606 may transmit 642 the usage probability of each Tx beam of known Tx-Rx beam pairs to the BS 604.

If the usage probability of a neighbor gNB or BS using a particular DL beam is high in a time window (e.g., a usage probability of 80%), the serving gNB or BS may avoid scheduling an incompatible DL beam (i.e., one that receives high interference from the particular DL beam) for its serving UE during that same time window. For example, the BS 606 may identify 634 a usage probability for using a Tx beam 614 (e.g., a usage probability of 80%) within a time window, and may transmit 642 that probability to the BS 604. The BS 604 may then, in response, avoid scheduling an Rx beam 612 to the UE 602 that receives high interference from the Tx beam 614 during that same time window. The BS 604 or the BS 606 may be able to determine whether a particular Rx beam 612 of the UE 602 may be interfered with by a Tx beam 614 of the BS 606 based on an SSB report or a layer 1 reference signal received power (L1-RSRP) generated by the BS 604. Such a report may be transmitted by the BS 604 to the BS 606 such that the BS 606 may adjust 654 a beam schedule for the UE 602, the BS 606, or the BS 604. Additionally, or alternatively, if the usage probability of a particular DL beam of a neighbor gNB or BS is high in a time window (e.g., a usage probability of 80%), the serving gNB or BS may be configured to transmit a signal of recommendation to the neighbor gNB or BS to reduce the usage probability for the conflicting beam. Such an instance may be triggered to occur in response to a serving gNB or BS being configured to transmit a URLLC message. For example, the BS 606 may identify 634 a usage probability of using a Tx beam 614 during a time window. The BS 606 may transmit 642 that probability to the BS 604. The BS 604 may be configured to transmit a URLLC message to the UE 602 using an Rx beam 612 during a time window, which may be known to be an Rx beam with which the Tx beam 614 interferes (i.e., the measured interference level meets or exceeds a threshold interference level). The BS 604 may then adjust 652 a beam schedule for the BS 606 to transmit the Tx beam 614 during a different time window, and may transmit 662 such a schedule notification to the BS 606 to alter its transmission of the Tx beam 614 to a different time window.

The BS 604 or the BS 606, or both the BS 604 and the BS 606, may be configured to adjust 652, 654, a beam schedule to minimize a probability of interference based upon the measured 622 interference levels for each Tx-Rx beam pair and the usage probability of the Rx beam, the usage probability of the Tx beam, or the usage probability of both beams of the Tx-Rx beam pairs. For example, the BS 604 may be configured to avoid scheduling a conflicting Rx beam during time windows when the BS 606 is known to have a high usage probability (e.g., a usage probability that meets or exceeds a usage threshold) of one or more Tx beams that interferes with that Rx beam. Additionally, or alternatively, the BS 604 may be configured to transmit 662 a schedule notification to the BS 606 to avoid transmitting one or more conflicting Tx beams during time windows when the BS 604 has a high usage probability to transmit a conflicting Rx beam. Additionally, or alternatively, the BS 606 may be configured to avoid scheduling one or more conflicting Tx beams during time windows when the BS 604 may have a high usage probability to transmit an Rx beam 612 to the UE 602 that is interfered with by the one or more conflicting Tx beams 614. Additionally, or alternatively, the BS 606 may be configured to transmit 662 a schedule notification to the BS 604 to avoid transmitting one or more conflicting Rx beams to the UE 602 during time windows when the BS 606 may have a high usage probability for a Tx beam 614 that interferes with the one or more conflicting Rx beams 612 transmitted to the UE 602. Additionally, or alternatively, the BS 604 and the BS 606 may exchange one or more beam schedules by transmitting 662 a schedule notification including a beam schedule. Adjusting a usage probability for a beam downwards may mean not using the beam at all (e.g., 0% usage probability), which may be suitable in situations where a usage probability for a conflicting beam is at or near 100%. Adjusting a usage probability for a beam upwards may mean using the beam during an entire time period (e.g., 100% usage probability), which may be suitable in situations where there is no measured interference between that beam and any other beam having a non-zero usage probability in a Tx-Rx matrix of measured interference levels.

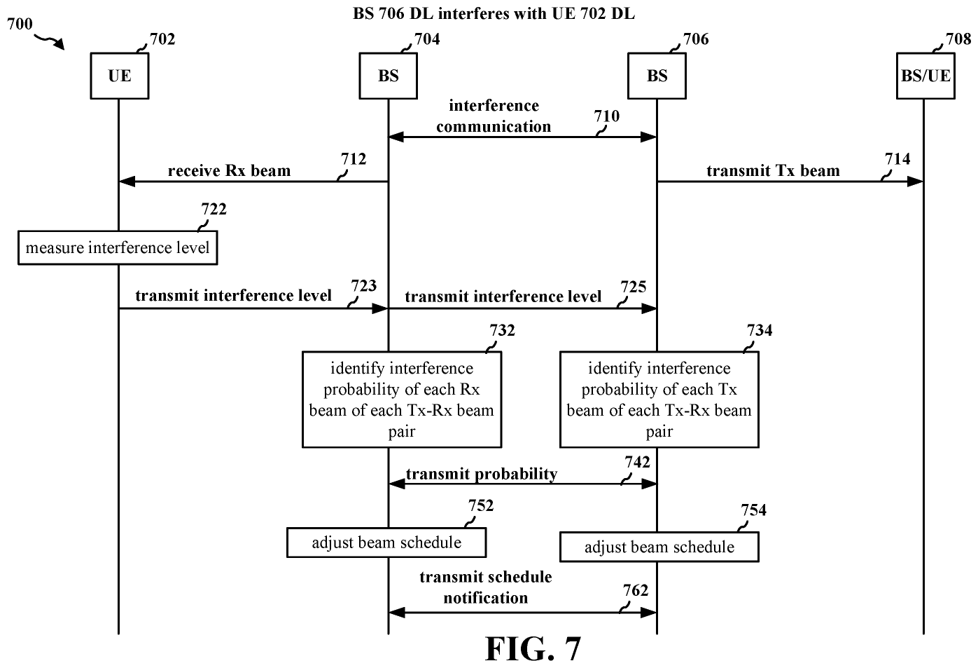

FIG. 7 shows a network connection flow diagram 700 that illustrates an example of a UE 702 and a BS 706 that may have a Tx beam 714 that may interfere with an Rx beam 712. The network connection flow diagram 700 has a UE 702, a BS 704, a BS 706, and a wireless device 708, which may be a BS or a UE. Similar to FIG. 6, when the BS 706 transmits a Tx beam 714 to the wireless device 708, the Tx beam 714 may interfere with an Rx beam 712 transmitted from the BS 704 to the UE 702. The network connection flow diagram 700 illustrates a use case for a neighbor gNB-to-serving UE interference where interference probability information of a gNB beam may be provided via inter-gNB messaging.

To determine what possible Tx beams from BS 706 may interfere with an Rx beam sent to UE 702, BS 706 may be configured to communicate with BS 704 using an interference communication 710, similar to FIG. 6. For example, the BS 706 may transmit, to the BS 704, a list of Tx beams that the BS 706 is capable of transmitting, the BS 704 may transmit, to the BS 706, a list of Rx beams that the UE 702 is capable of receiving, the BS 704 may transmit, to the BS 706, a Tx-Rx matrix of known interference levels of UE 702 (or a device type similar to the device type of UE 702) such that BS 706 knows what Tx beams may interfere with Rx beams of UE 702, and/or the BS 704 may transmit, to the BS 706, a Tx-Rx matrix of known interference probabilities such that BS 706 knows what Tx beams have a high probability of creating an interference with Rx beams of UE 702 (or a device type similar to the device type of UE 702). The BS 704 and the BS 706 may also use interference communication 710 signals to configure a series of tests for BS 706 to transmit one or more measurement RS Tx beams 714 while UE 702 receives an Rx beam 712 to determine which Tx beams 714 may interfere with Rx beams 712 of UE 702, and to what extent.

While a measurement RS may be sent from an aggressor gNB while a victim UE receives a signal to measure actual interference, similarly with regard to BS 404 and BS 406 in FIG. 4, a Tx-Rx matrix of known interference levels or known interference probabilities for a similar UE (e.g., a UE of the same make and model) may be used to estimate what Tx beams from BS 706 may interfere with Rx beams transmitted to UE 702. Additionally, or alternatively, a test UE 702 may be used to generate such a Tx-Rx matrix, which may be configured to analyze how much interference various Rx beams 712 may receive while various Tx beams 714 are transmitted from the BS 706. The BS 706 may be configured to transmit a measurement RS for each Tx for known Tx-Rx beam pairs between the BS 706 and the UE 702. For each Tx-Rx beam pair, the UE 702 may be configured to measure 722 an interference level to determine what Tx beams interfere with Rx beams sent to the UE 702. An interference level may be measured in a plurality of ways, as discussed above. The UE 702 may transmit 723 at least some of the measurement results to the BS 704, which may transmit 725 at least some of the measurement results to the BS 706. The measurement results may be used to populate a Tx-Rx matrix that indicates interference levels for each Tx-Rx combination, as described above.

The BS 704 may identify 732 an interference probability for each Rx beam of each Tx-Rx beam pair. Additionally, or alternatively, the BS 704 may identify 732 an interference probability for each Rx beam of each Tx-Rx beam pair where the Rx beam had a measured interference level that meets or exceeds a minimum threshold value, such as at least 10% or at least 100 bytes per minute or at least 15% of a time window. Alternatively, or additionally, the BS 706 may identify 734 an interference probability for each Tx beam of each Tx-Rx beam pair. Alternatively, or additionally, the BS 706 may identify 734 an interference probability for each Tx beam of each Tx-Rx beam pair where the Tx beam had caused a measured interference level that meets or exceeds a minimum threshold value. The BS 704 may transmit 742 the interference probability of each Rx beam of each Tx-Rx beam pair to the BS 706, and/or the BS 706 may transmit 742 the interference probability of each Tx beam of each Tx-Rx beam pair to the BS 704.

If the interference probability of a particular DL beam of a particular gNB or BS is high (e.g., meets or exceeds an interference level threshold) with respect to a particular DL beam of a serving UE, the serving gNB or BS may be configured to, in response, avoid scheduling its serving UE that receives high interference from that particular neighbor gNB's or BS's DL beam in the time window that the particular DL beam is transmitted. For example, the BS 706 may identify 734 an interference probability of a particular Tx beam 714 to be above 80% when the BS 704 transmits an Rx beam 712 to the UE 702, and may transmit 742 that probability to the BS 704. Additionally, or alternatively, the BS 704 may identify 732 an interference probability of a particular Rx beam 712 to be above 80% when the BS 706 transmits a Tx beam 714 to the wireless device 708. In response, the BS 704 may be configured to adjust 752 the beam schedule for the Rx beam 712 to avoid transmitting the Rx beam 712 to the UE 702 during a time window in which the BS 706 is transmitting the interfering Tx beam 714.

The BS 704 or the BS 706 may be able to determine whether the Rx beam 712 of the UE 702 was interfered with by the Tx beam 714 of the BS 706 based on an SSB report or a layer 1 reference signal received power (L1-RSRP) generated by the BS 704. Such a report may be transmitted by the BS 704 to the BS 706 such that, in response, the BS 706 may adjust 754 a beam schedule for the UE 702 or the BS 706. Additionally, or alternatively, if the interference probability of a particular DL beam of a particular gNB or BS is high (e.g., meets or exceeds an interference level threshold) with respect to a particular DL beam of a serving UE, the serving gNB or BS may be configured to, in response, transmit a signal of recommendation to the neighbor gNB or BS to request to not transmit the particular DL beam during a given time window. Such an instance may be triggered to occur in response to a serving gNB or BS being configured to transmit a URLLC message. For example, the BS 706 may identify 734 an interference probability of a particular Tx beam 714 to be above 80% when the BS 704 transmits an Rx beam 712 to the UE 702, and may transmit 742 that probability to the BS 704. Additionally, or alternatively, the BS 704 may identify 732 an interference probability of a particular Rx beam 712 to be above 80% when the BS 706 transmits a Tx beam 714 to the wireless device 708. In response, the BS 704 may be configured to adjust 752 a beam schedule for the BS 706 to transmit the interfering Tx beam 714 during a different time window, and may transmit 762 such a schedule notification to the BS 706 to alter its transmission of the Tx beam 714 to a different time window so as to not overlap with the time window of the Rx beam 712.

The BS 704 or the BS 706, or both the BS 704 and the BS 706 may be configured to adjust 752, 754, a beam schedule to minimize a probability of interference based upon the measured interference levels for each Tx-Rx beam pair and the interference probability of the Rx beam, the interference probability of the Tx beam, or the interference probability of both beams of the Tx-Rx beam pairs. For example, the BS 704 may be configured to avoid scheduling a conflicting Rx beam during time windows when the BS 706 is known to have a high usage probability of one or more Tx beams that interferes with that Rx beam. Additionally, or alternatively, the BS 704 may be configured to transmit 762 a schedule notification to the BS 706 to avoid transmitting one or more conflicting Tx beams during time windows when the BS 704 has a high usage probability to transmit a conflicting Rx beam to the UE 702. Additionally, or alternatively, the BS 706 may be configured to avoid scheduling one or more conflicting Tx beams during time windows when the BS 704 may have a high usage probability to transmit an Rx beam 712 to the UE 702 that is interfered with by the one or more conflicting Tx beams 714. Additionally, or alternatively, the BS 706 may be configured to transmit 762 a schedule notification to the BS 704 to avoid transmitting one or more conflicting Rx beams to the UE 702 during time windows when the BS 706 may have a high usage probability for a Tx that interferes with the one or more conflicting Rx beams transmitted to the UE 702. Adjusting a usage probability for a beam downwards may mean not using the beam at all (e.g., 0% usage probability), which may be suitable in situations where a usage probability for a conflicting beam is at or near 100%. Adjusting a usage probability for a beam upwards may mean using the beam during an entire time period (e.g., 100% usage probability), which may be suitable in situations where there is no measured interference between that beam and any other beam having a non-zero usage probability in a Tx-Rx matrix of measured interference levels.

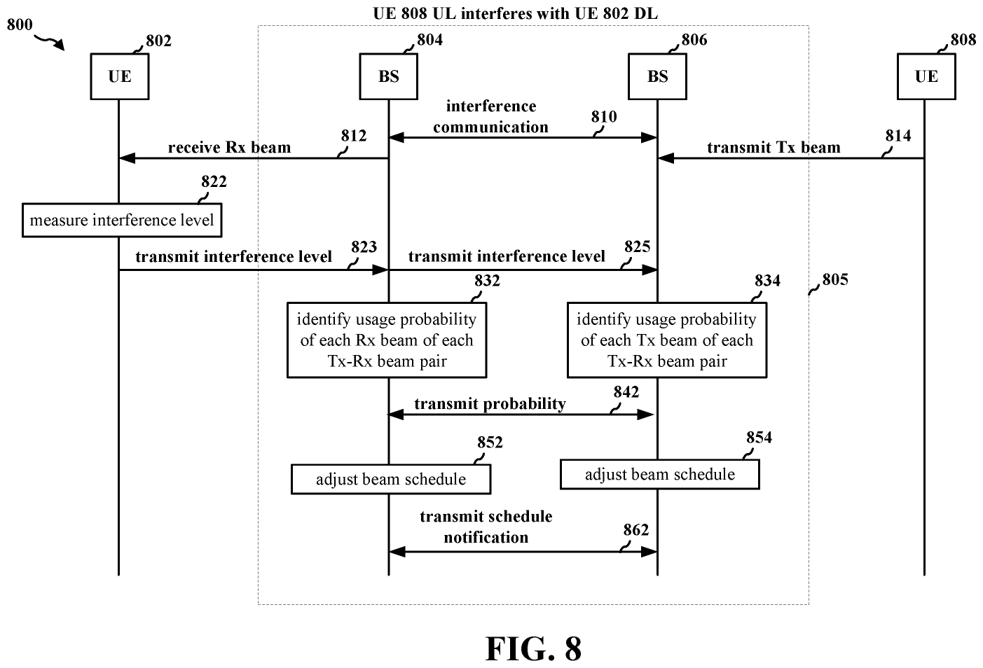

FIG. 8 shows a network connection flow diagram 800 that illustrates an example of a UE 802 and a UE 808 that may have a Tx beam 814 that may interfere with an Rx beam 812. The network connection flow diagram 800 has a UE 802, a BS 804, a BS 806, and a UE 808. When the UE 808 transmits a Tx beam 814 to the BS 806, the Tx beam 814 may interfere with an Rx beam 812 transmitted from the BS 804 to the UE 802. The devices may be configured to perform inter-UE CLI mitigation to minimize possible interference between a Tx beam 814 from UE 808 and an Rx beam 812 to UE 802. In other words, the network connection flow diagram 800 illustrates a use case for inter-UE CLI mitigation. Usage probability of UE beam assistance information from a UE to a gNB may be indicated using a UE UL beam ID.

To determine what possible Tx beams from UE 808 may interfere with an Rx beam sent to UE 802, BS 806 may be configured to communicate with BS 804 using an interference communication 810. For example, the BS 806 may transmit, to the BS 804, a list of Tx beams that the UE 808 is capable of transmitting to the BS 806, the BS 804 may transmit, to the BS 806, a list of Rx beams that the UE 802 is capable of receiving, the BS 804 may transmit, to the BS 806, a Tx-Rx matrix of known interference levels of UE 802 (or a device type similar to the device type of UE 802) such that BS 806 knows what Tx beams may interfere with Rx beams of UE 802, and/or the BS 804 may transmit, to the BS 806, a Tx-Rx matrix of known interference probabilities such that BS 806 knows what Tx beams have a high probability of creating an interference with Rx beams of UE 802 (or a device type similar to the device type of UE 802). The BS 804 and the BS 806 may also use interference communication 810 signals to configure a series of tests for UE 808 to transmit one or more measurement RS Tx beams 814 while UE 802 receives an Rx beam 812 to determine which Tx beams 814 may interfere with Rx beams 812 of UE 802, and to what extent.

While a measurement signal may be sent from an aggressor UE while a victim UE receives a signal to measure actual interference, similarly with regard to BS 404 and BS 406 in FIG. 4, a Tx-Rx matrix of known interference levels or known interference probabilities for a similar UE (e.g., a UE of the same make and model) may be used to estimate what Tx beams from UE 808 may interfere with Rx beams transmitted to UE 802. Additionally, or alternatively, a test UE 802 may be used to generate such a Tx-Rx matrix, which may be configured to analyze how much interference various Rx beams 812 may receive while various Tx beams 814 are transmitted from the UE 808. For each possible Tx-Rx beam pair, the UE 802 may be configured to measure 822 an interference level to determine what Tx beams 814 interfere with Rx beams 812 sent to the UE 802. An interference level may be measured in a plurality of ways, as explained above. The UE 802 may transmit 823 at least some of the measurement results to the BS 804, which may transmit 825 at least some of the measurement results to the BS 806. The measurement results may be used to populate a Tx-Rx matrix that indicates interference levels for each Tx-Rx combination, as described above.

The BS 804 may identify 832 a usage probability for each Rx beam of each Tx-Rx beam pair. Additionally, or alternatively, the BS 806 may identify 834 a usage probability for each Tx beam of each Tx-Rx beam pair. An exact UE UL beam ID usage probability of UE 808 may be reported or transmitted 842 to the BS 804 or to the BS 806. Doing so may avoid inter-UE CLI. In other words, the UE 808 may transmit a derived UL beam ID usage probability to the BS 806. Additionally, or alternatively, the BS 806 may transmit a derived UL beam ID usage probability for UE 808 to the BS 804. For example, UE 808 may report or transmit 842 a usage probability of a spatial filter corresponding to an SRS resource ID mapped to a given beam indication DL RS. Additionally, or alternatively, the UE 808 may report or transmit 842 a usage probability of a spatial filter corresponding to an SRS resource ID, regardless of whether it is mapped to which DL RS. Alternatively, or additionally, the BS 806 may report or transmit 842 one or both aforementioned usage probabilities. Such a usage probability may be reported or transmitted 842 as a function of a previous time window, for example in milliseconds. Based on such information, the BS 804 and/or the BS 806 may adjust 854 a beam schedule for the UE 808 and/or the UE 802 that results in a low CLI to its neighbor UE 802 in a time window.

If the usage probability of a UE of a neighbor gNB or BS using a particular UL beam is high in a time window (e.g., 80% usage probability), the serving gNB or BS may be configured to avoid scheduling an incompatible DL beam (i.e., one that receives high interference from the particular UL beam) for its serving UE during that same time window. For example, the BS 806 may identify 834 a usage probability for a Tx beam 814 to be transmitted by the UE 808 to be at or above 80% in a time window, and may transmit 842 that probability to the BS 804. In response, the BS 804 may be configured to adjust 852 a beam schedule to transmit a non-compatible Rx beam 812 (i.e., a beam that receives at least a threshold level of interference from the Tx beam 814) in a different time window. Additionally, or alternatively, if the usage probability of a UE of a neighbor gNB or BS using a particular UL beam is high in a time window, the serving gNB or BS may be configured to transmit a signal of recommendation to the neighbor gNB or BS to request to schedule the UL beam during a different time window. Such an instance may be triggered to occur in response to a serving gNB or BS being configured to transmit a URLLC message. For example, the BS 806 may identify 834 a usage probability for a Tx beam 814 to be transmitted by the UE 808 to be at or above 80% in a time window, and may transmit 842 that probability to the BS 804. The BS 804 may also be configured to transmit a URLLC message as an Rx beam 812 to the UE 802 in that same time window. In response, the BS 804 may be configured to adjust 852 a beam schedule to transmit the non-compatible Tx beam 814 during a different time window. The BS 804 may then transmit 862 a schedule notification of the new beam schedule to the BS 806 to alter a time for the UE 808 to transmit the Tx beam 814, or to lower the usage probability to transmit the Tx beam 814 during that time window to be at or below a threshold value.

The BS 804 or the BS 806, or both the BS 804 and the BS 806, may be configured to adjust 852, 854, a beam schedule to minimize a probability of interference based upon the measured interference levels for each Tx-Rx beam pair and the usage probability of the Rx beam, the usage probability of the Tx beam, or the usage probability of both beams of the Tx-Rx beam pairs. For example, the BS 804 may be configured to avoid scheduling a conflicting Rx beam during time windows when the UE 808 is known to have a high usage probability of one or more Tx beams that interferes with that Rx beam. Additionally, or alternatively, the BS 804 may be configured to transmit 862 a schedule notification to the BS 806 to avoid scheduling a transmission of one or more conflicting Tx beams from the UE 808 during time windows when the BS 804 has a high usage probability to transmit a conflicting Rx beam to the UE 802. Additionally, or alternatively, the BS 806 may be configured to avoid scheduling one or more conflicting Tx beams from the UE 808 during time windows when the BS 804 may have a high usage probability to transmit an Rx beam 812 to the UE 802 that is interfered with by the one or more conflicting Tx beams 814. Additionally, or alternatively, the BS 806 may be configured to transmit 862 a schedule notification to the BS 804 to avoid transmitting one or more conflicting Rx beams to the UE 802 during time windows when the UE 808 may have a high usage probability for a Tx that interferes with the one or more conflicting Rx beams transmitted to the UE 802. Adjusting a usage probability for a beam downwards may mean not using the beam at all (e.g., 0% usage probability), which may be suitable in situations where a usage probability for a conflicting beam is at or near 100%. Adjusting a usage probability for a beam upwards may mean using the beam during an entire time period (e.g., 100% usage probability), which may be suitable in situations where there is no measured interference between that beam and any other beam having a non-zero usage probability in a Tx-Rx matrix of measured interference levels.

In one aspect, the UE 808 may transmit a Tx beam 814 that interferes with an Rx beam 812 received by a UE 802 where both the UE 808 and the UE 802 may communicate with the same BS in FD mode. For example, both the BS 804 and the BS 806 may be represented by a BS 805 in FD mode, where the UE 808 may transmit a Tx beam 814 to the BS 805 while the BS 805 transmits an Rx beam 812 to the UE 802. In some instances, the functions of the BS 804 and the BS 806 may be performed by a single BS 805.

For example, the BS 805 may generate a Tx-Rx matrix of known interference levels for Tx beams 814 of the UE 808 that may interfere with Tx beams 812 of the UE 802, or may schedule a series of tests for UE 808 to transmit one or more measurement RS Tx beams 814 while UE 802 receives an Rx beam 812 to determine which Tx beams 814 may interfere with Rx beams 812 of UE 802, and to what extent. The UE 802 may measure 822 an interference level of any Rx beams 812 that are interfered with by a Tx beam 814 transmitted from UE 808. The UE 802 may transmit 823 one or more interference levels to the BS 805, which may determine what Rx beams 812 are significantly interfered with by Tx beams 814 of the UE 808. The BS 805 may identify 832 a usage probability of each Rx beam for each Tx-Rx beam pair, and may identify 834 a usage probability of each Tx beam for each Tx-Rx beam pair which may be used for scheduling. Additionally, or alternatively, the BS 805 may simply adjust 852, 854, a beam schedule for both the UE 808 and the UE 802 to minimize interference with an Rx beam 812 of the UE 802 by a Tx beam 814 of the UE 808. As the BS 805 may be able to schedule such beams for both the UE 802 and the UE 808, the BS 805 may be able to quickly and efficiently adjust 852, 854 beam schedules for the UE 802 and the UE 808.

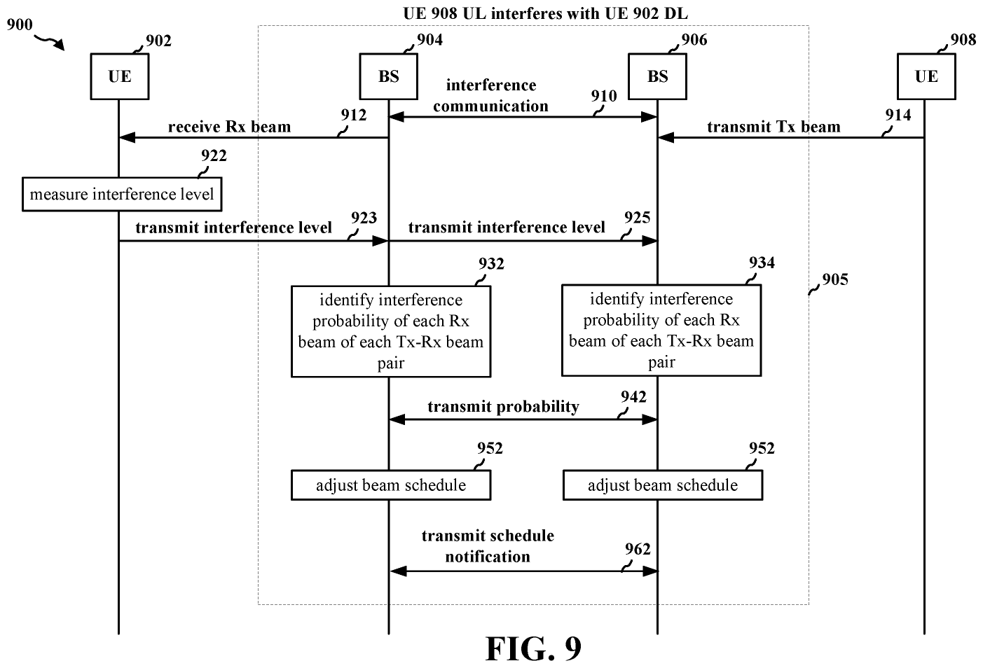

FIG. 9 shows a network connection flow diagram 900 that illustrates an example of a UE 902 and a UE 908 that may have a Tx beam 914 that may interfere with an Rx beam 912. The network connection flow diagram 900 has a UE 902, a BS 904, a BS 906, and a UE 908. When the UE 908 transmits a Tx beam 914 to the BS 906, the Tx beam 914 may interfere with an Rx beam 912 transmitted from the BS 904 to the UE 902. The devices may be configured to perform inter UE CLI mitigation to minimize possible interference between a Tx beam 914 from UE 908 and an Rx beam 912 to UE 902. In other words, the network connection flow diagram 900 illustrates a use case for inter-UE CLI mitigation.

To determine what possible Tx beams from UE 908 may interfere with an Rx beam sent to UE 902, BS 906 may be configured to communicate with BS 904 using an interference communication 910. For example, the BS 906 may transmit, to the BS 904, a list of Tx beams that the UE 908 is capable of transmitting to the BS 906, the BS 904 may transmit, to the BS 906, a list of Rx beams that the UE 902 is capable of receiving, the BS 904 may transmit, to the BS 906, a Tx-Rx matrix of known interference levels of UE 902 (or a device type similar to the device type of UE 902) such that BS 906 knows what Tx beams may interfere with Rx beams of UE 902, or the BS 904 may transmit, to the BS 906, a Tx-Rx matrix of known interference probabilities such that BS 906 knows what Tx beams have a high probability of creating an interference with Rx beams of UE 902 (or a device type similar to the device type of UE 902). The BS 904 and the BS 906 may also use interference communication 910 signals to configure a series of tests for UE 908 to transmit one or more measurement RS Tx beams 914 while UE 902 receives an Rx beam 912 to determine which Tx beams 914 may interfere with Rx beams 912 of UE 902, and to what extent.

While a measurement signal may be sent from an aggressor UE while a victim UE receives a signal to measure actual interference, similarly with regard to UE 808 and UE 802 in FIG. 8, a Tx-Rx matrix of known interference levels or known interference probabilities for a similar UE (e.g., a UE of the same make and model) may be more used to estimate what Tx beams from UE 908 may interfere with Rx beams transmitted to UE 902. Additionally, or alternatively, a test UE 902 may be used to generate such a Tx-Rx matrix, which may be configured to analyze how much interference various Rx beams 912 may receive while various Tx beams 914 are transmitted from the UE 908. For each Tx-Rx beam pair, the UE 902 may be configured to measure 922 an interference level to determine what Tx beams interfere with Rx beams sent to the UE 902. An interference level may be measured in a plurality of ways, as explained above. The UE 902 may transmit 923 at least some of the measurement results to the BS 904, which may transmit 925 at least some of the measurement results to the BS 906. The measurement results may be used to populate a Tx-Rx matrix that indicates interference levels for each Tx-Rx combination, as described above.

The BS 904 may identify 932 an interference probability for each Rx beam of each Tx-Rx beam pair. Additionally, or alternatively, the BS 906 may identify 934 an interference probability for each Tx beam of each Tx-Rx beam pair. An interference probability for each Tx-Rx beam pair may be derived, for example, by analyzing data from the constructed Tx-Rx matrix, or by retrieving such data from databases having pre-constructed Tx-Rx matrices for UEs of the same type as UE 902 and UE 908, respectively. An identified interference probability may be used to minimize interference between the Tx beams of the UE 908 and the Rx beams of the UE 902.

If the interference probability of a particular UL beam of a neighbor UE with respect to a DL beam of a serving UE is high (e.g., at or above an interference probability threshold), the serving gNB or BS may be configured to avoid scheduling the incompatible DL beam for its serving UE during that same time window. For example, the BS 906 may identify 934 an interference probability for a Tx beam 914 to be transmitted by the UE 908 to be at or above 80% when the BS 904 transmits an Rx beam 912 to the UE 902, and may transmit 942 that probability to the BS 904. Additionally, or alternatively, the BS 904 may identify 932 an interference probability for an Rx beam 912 received by the UE 902 to be at or above 80% when the UE 908 transmits a Tx beam 914. In response, the BS 904 may be configured to adjust 952 a beam schedule to transmit a non-compatible Rx beam 912 in a different time window. Additionally, or alternatively, if the interference probability of a particular UL beam of a neighbor UE with respect to a DL beam of a serving UE is high (e.g., at or above an interference probability threshold), the serving gNB or BS may be configured to transmit a signal of recommendation to the neighbor gNB or BS to request to schedule the UL beam during a different time window. Such an instance may be triggered to occur in response to a serving gNB or BS being configured to transmit a URLLC message. For example, the BS 906 may identify 934 an interference probability for a Tx beam 914 to be transmitted by the UE 908 to be at or above 80% when the BS 904 transmits an Rx beam 912 to the UE 902, and may transmit 942 that probability to the BS 904. Additionally, or alternatively, the BS 904 may identify 932 an interference probability for an Rx beam 912 received by the UE 902 to be at or above 80% when the UE 908 transmits a Tx beam 914. The BS 904 may also be configured to transmit a URLLC message as an Rx beam 912 to the UE 902 in a same time window that the UE 908 is configured to transmit the Tx beam 914. In response, the BS 904 may be configured to adjust 952 a beam schedule to transmit the non-compatible Tx beam 914 during a different time window. The BS 904 may then transmit 962 a schedule notification of the new beam schedule to the BS 906 to alter a time for the UE 908 to transmit the Tx beam 914, or to lower the usage probability to transmit the Tx beam 914 during that time window to be at or below a threshold value.

The BS 904 or the BS 906, or both the BS 904 and the BS 906, may be configured to adjust 952, 954, a beam schedule to minimize a probability of interference based upon the measured interference levels for each Tx-Rx beam pair and the interference probability of the Rx beam, the interference probability of the Tx beam, or the interference probability of both beams of the Tx-Rx beam pairs. For example, the BS 904 may be configured to avoid scheduling a conflicting Rx beam during time windows when the UE 908 is known to have a high usage probability of one or more Tx beams that interferes with that Rx beam. Additionally, or alternatively, the BS 904 may be configured to transmit 962 a schedule notification to the BS 906 to avoid scheduling a transmission of one or more conflicting Tx beams from the UE 908 during time windows when the BS 904 has a high usage probability to transmit a conflicting Rx beam to the UE 902. Additionally, or alternatively, the BS 906 may be configured to avoid scheduling one or more conflicting Tx beams from the UE 908 during time windows when the BS 904 may have a high usage probability to transmit an Rx beam 912 to the UE 902 that is interfered with by the one or more conflicting Tx beams 914. Additionally, or alternatively, the BS 906 may be configured to transmit 962 a schedule notification to the BS 904 to avoid transmitting one or more conflicting Rx beams to the UE 902 during time windows when the UE 908 may have a high usage probability for a Tx that interferes with the one or more conflicting Rx beams transmitted to the UE 902. Adjusting a usage probability for a beam downwards may mean not using the beam at all (e.g., 0% usage probability), which may be suitable in situations where a usage probability for a conflicting beam is at or near 100%. Adjusting a usage probability for a beam upwards may mean using the beam during an entire time period (e.g., 100% usage probability), which may be suitable in situations where there is no measured interference between that beam and any other beam having a non-zero usage probability in a Tx-Rx matrix of measured interference levels.

In one aspect, the UE 908 may transmit a Tx beam 914 that interferes with an Rx beam 912 received by a UE 902 where both the UE 908 and the UE 902 may communicate with the same BS in FD mode. For example, both the BS 904 and the BS 906 may be represented by a BS 905 in FD mode, where the UE 908 may transmit a Tx beam 914 to the BS 905 while the BS 905 transmits an Rx beam 912 to the UE 902. The functions of the BS 904 and the BS 906 may be performed by a single BS 905.

For example, the BS 905 may generate a Tx-Rx matrix of known interference levels for Tx beams 914 of the UE 908 that may interfere with Tx beams 912 of the UE 902, or may schedule a series of tests for UE 908 to transmit one or more measurement RS Tx beams 914 while UE 902 receives an Rx beam 912 to determine which Tx beams 914 may interfere with Rx beams 912 of UE 902, and to what extent. The UE 902 may measure 922 an interference level of any Rx beams 912 that are interfered with by a Tx beam 914 transmitted from UE 908. The UE 902 may transmit 923 one or more interference levels to the BS 905, which may determine what Rx beams 912 are significantly interfered with by Tx beams 914 of the UE 908. The BS 905 may identify 932 an interference probability of each Rx beam for each Tx-Rx beam pair, and/or may identify 934 an interference probability of each Tx beam for each Tx-Rx beam pair which may be used for scheduling. Additionally, or alternatively, the BS 905 may simply adjust 952, 954, a beam schedule for both the UE 908 and the UE 902 to minimize interference with an Rx beam 912 of the UE 902 by a Tx beam 914 of the UE 908. Such a schedule may be based on an identified interference probability for at least one of the Tx-Rx beam pairs. As the BS 905 may be able to schedule such beams for both the UE 902 and the UE 908, the BS 905 may be able to quickly and efficiently adjust 952, 954 beam schedules for the UE 902 and the UE 908.

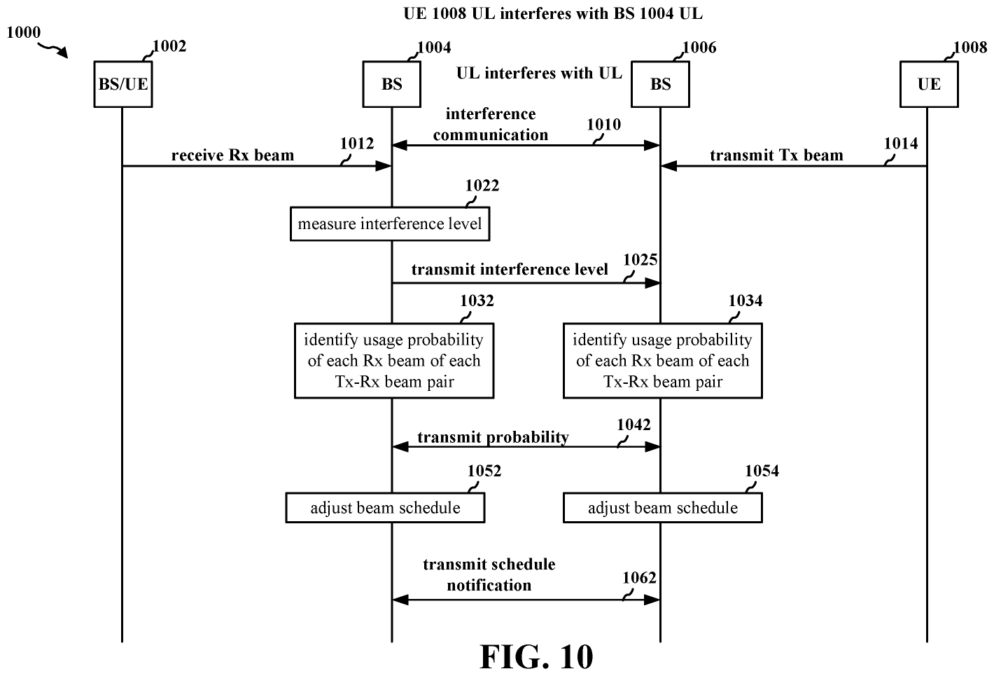

FIG. 10 shows a network connection flow diagram 1000 that illustrates an example of a BS 1004 and a UE 1008 that may have a Tx beam 1014 that may interfere with an Rx beam 1012. The network connection flow diagram 1000 has a wireless device 1002, which may be a BS or a UE, a BS 1004, a BS 1006, and a UE 1008. When the UE 1008 transmits a Tx beam 1014 to the BS 1006, the Tx beam 1014 may interfere with an Rx beam 1012 transmitted from the wireless device 1002 to the BS 1004. The network connection flow diagram 1000 illustrates a use case for a neighbor UE interfering with a serving gNB interface. Usage probability of UE beam assistance information from a UE to a gNB may be indicated using a UE UL beam ID.

To determine what possible Tx beams from UE 1008 may interfere with an Rx beam sent to the BS 1004, BS 1006 may be configured to communicate with BS 1004 using an interference communication 1010. For example, the BS 1006 may transmit, to the BS 1004, a list of Tx beams that the UE 1008 is capable of transmitting to the BS 1004, the BS 1004 may transmit, to the BS 1006, a list of Rx beams that the wireless device 1002 is capable of transmitting to the BS 1004, the BS 1004 may transmit, to the BS 1006, a Tx-Rx matrix of known interference levels of Rx beams sent to BS 1004 such that BS 1006 knows what Tx beams may interfere with Rx beams of BS 1004, and/or the BS 1004 may transmit, to the BS 1006, a Tx-Rx matrix of known interference probabilities such that BS 1006 knows what Tx beams have a high probability of creating an interference with Rx beams of BS 1004. The BS 1004 and the BS 1006 may also use interference communication 1010 signals to configure a series of tests for UE 1008 to transmit one or more measurement signal Tx beams 1014 while BS 1004 receives an Rx beam 1012 to determine which Tx beams 1014 may interfere with Rx beams 1012 of BS 1004, and to what extent.

In some aspects, a measurement RS may be sent from an aggressor UE while a victim gNB or BS receives a transmission to measure actual interference. For example, the BS 1006 may be configured to receive Tx beams 1014 from the UE 1008 while the BS 1004 receives Rx beam 1012 from the wireless device 1002 to determine how such signals may interfere with various Rx beams transmitted to the BS 1004. For each Tx-Rx beam pair, the BS 1004 may be configured to measure 1022 an interference level to determine what Tx beams interfere with Rx beams sent to the BS 1004. An interference level may be measured in a plurality of ways, as discussed above. The BS 1004 may transmit 1025 at least some of the measurement results to the BS 1006. The measurement results may be used to populate a Tx-Rx matrix that indicates interference levels for each Tx-Rx combination, as described above. Such a matrix may be used in the future by BS 1004 or be transmitted to any other device, such as the BS 1006, to convey which Tx beam signals from a UE of the type of UE 1008 may interfere with Rx beam signals received by BS 1004.

The BS 1004 may identify 1032 a usage probability for each Rx beam of each Tx-Rx beam pair. Additionally, or alternatively, the BS 1004 may identify 1032 a usage probability for each Rx beam of each Tx-Rx beam pair where the Rx beam had a measured interference level that meets or exceeds a minimum threshold, such as at least 10% or at least than 100 bytes per minute or at least 15% of a time window. Alternatively, or additionally, the BS 1006 may identify 1034 a usage probability for each Tx beam of each Tx-Rx beam pair. Alternatively, or additionally, the BS 1006 may identify 1034 a usage probability for each Tx beam of each Tx-Rx beam pair where the Tx beam had caused a measured interference level that meets or exceeds a minimum threshold value. The BS 1004 may transmit 1042 the usage probability of each Rx beam of each Tx-Rx beam pair to the BS 1006, and/or the BS 1006 may transmit 1042 the usage probability of each Tx beam of each Tx-Rx beam pair to the BS 1004.

For example, an exact UE UL beam ID usage probability may be reported to the BS 1004 or to the BS 1006. Doing so may avoid neighbor UE-to-serving gNB interface. In other words, the UE 1008 may transmit a derived UL beam ID usage probability to the BS 1006. The BS 1006 may transmit a derived UL beam ID usage probability for UE 1008 to the BS 1004. For example, the UE 1008 may be configured to report a usage probability of a spatial filter corresponding to an SRS resource ID mapped to a given beam indication DL RS. Additionally, or alternatively, the UE 1008 may be configured to report a usage probability of a spatial filter corresponding to an SRS resource ID, regardless of whether it is mapped to which DL RS. Alternatively, or additionally, the BS 1006 may report one or both aforementioned usage probabilities. Such a usage probability may be reported as a function of a previous time window, for example in milliseconds. Based on such information, a serving or neighbor gNB may avoid scheduling decisions that have a high neighbor UE-to-serving gNB interference scenario in a time window.

If the usage probability of a particular UL beam of a neighbor UE is high (e.g., at or above a threshold value) within a time window, the serving gNB or BS may be configured to avoid scheduling an UL beam from a wireless device during that time window. For example, the BS 1006 may identify 1034 a usage probability for the UE 1008 to transmit a Tx beam 1014 to the BS 1006 at 80% within a time window, and may transmit 1042 that probability to the BS 1004. The BS 1004 may then, in response, avoid scheduling an Rx beam 1012 from the wireless device 1002 to the BS 1004 that receives high interference from the Tx beam 1014 during that same time window. Additionally, or alternatively, if the usage probability of a particular UL beam of a neighbor UE is high (e.g., at or above a threshold value) within a time window, the serving gNB or BS may be configured to transmit a signal of recommendation to the neighbor gNB or BS to reduce the usage probability for the conflicting beam. For example, the BS 1006 may identify 1034 a usage probability for the UE 1008 to transmit a Tx beam 1014 to the BS 1006 at 80% within a time window, and may transmit 1042 that probability to the BS 1004. The BS 1004 may then, in response, adjust 1052 a beam schedule for the UE 1008 to transmit the Tx beam 1014 during a different time window, and may transmit 1062 such a schedule notification to the BS 1006 to alter the schedule of the Tx beam 1014 from the UE 1008 to a different time window.

The BS 1004 or the BS 1006, or both the BS 1004 and the BS 1006, may be configured to adjust 1052, 1054, a beam schedule to minimize a probability of interference based upon the measured interference levels for each Tx-Rx beam pair and the usage probability of the Rx beam, the usage probability of the Tx beam, or the usage probability of both beams of the Tx-Rx beam pairs. For example, the BS 1004 may be configured to avoid scheduling a conflicting Rx beam during time windows when the UE 1008 is known to have a high usage probability of one or more Tx beams that interferes with that Rx beam. Additionally, or alternatively, the BS 1004 may be configured to transmit 1062 a schedule notification to the BS 1006 to avoid transmitting one or more conflicting Tx beams during time windows when the BS 1004 has a high usage probability to receive a conflicting Rx beam from the wireless device 1002. Additionally, or alternatively, the BS 1006 may be configured to avoid scheduling one or more conflicting Tx beams during time windows when the BS 1004 may have a high usage probability to receive an Rx beam 1012 from the wireless device 1002 that is interfered with by the one or more conflicting Tx beams 1014. Additionally, or alternatively, the BS 1006 may be configured to transmit 1062 a schedule notification to the BS 1004 to avoid receiving one or more conflicting Rx beams from the wireless device 1002 during time windows when the BS 1006 may have a high usage probability for a Tx that interferes with the one or more conflicting Rx beams transmitted from the wireless device 1002. Adjusting a usage probability for a beam downwards may mean not using the beam at all (e.g., 0% usage probability), which may be suitable in situations where a usage probability for a conflicting beam is at or near 100%. Adjusting a usage probability for a beam upwards may mean using the beam during an entire time period (e.g., 100% usage probability), which may be suitable in situations where there is no measured interference between that beam and any other beam having a non-zero usage probability in a Tx-Rx matrix of measured interference levels.

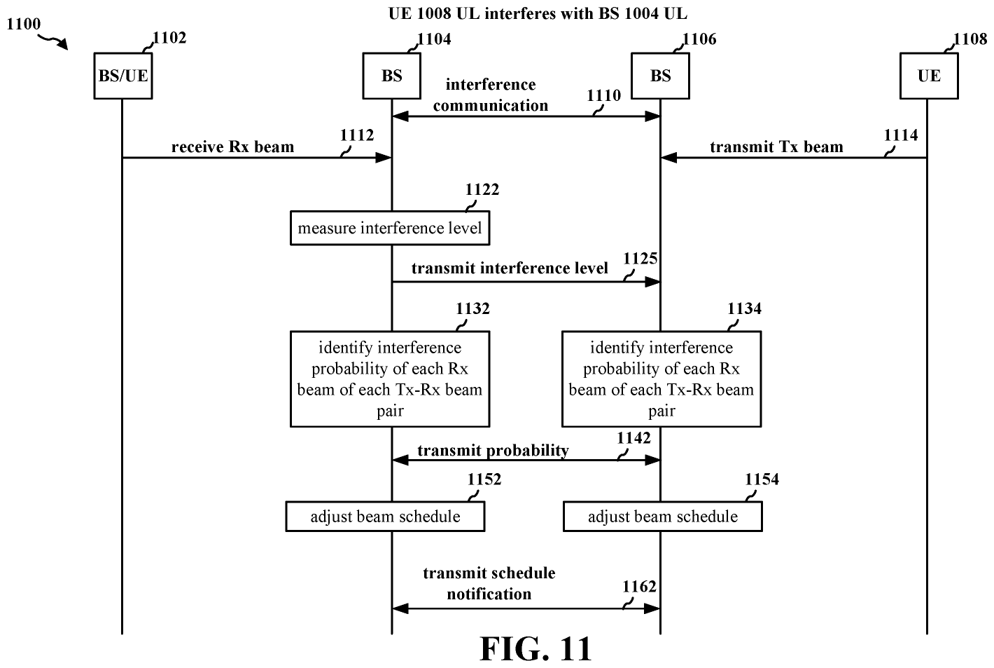

FIG. 11 shows a network connection flow diagram 1100 that illustrates an example of a BS 1104 and a UE 1108 that may have a Tx beam 1114 that may interfere with an Rx beam 1112. The network connection flow diagram 1100 has a wireless device 1102, which may be a BS or a UE, a BS 1104, a BS 1106, and a UE 1108. When the UE 1108 transmits a Tx beam 1114 to the BS 1106, the Tx beam 1114 may interfere with an Rx beam 1112 transmitted from the wireless device 1102 to the BS 1104. The network connection flow diagram 1100 illustrates a use case for a neighbor UE interfering with a serving gNB interface.

To determine what possible Tx beams from UE 1108 may interfere with an Rx beam sent to wireless device 1102, BS 1106 may be configured to communicate with BS 1104 using an interference communication 1110. For example, the BS 1106 may transmit, to the BS 1104, a list of Tx beams that the UE 1108 is capable of transmitting to the BS 1104, the BS 1104 may transmit, to the BS 1106, a list of Rx beams that the wireless device 1102 is capable of transmitting to the BS 1104, the BS 1104 may transmit, to the BS 1106, a Tx-Rx matrix of known interference levels of Rx beams sent to BS 1104 such that BS 1106 knows what Tx beams may interfere with Rx beams of BS 1104, and/or the BS 1104 may transmit, to the BS 1106, a Tx-Rx matrix of known interference probabilities such that BS 1106 knows what Tx beams have a high probability of creating an interference with Rx beams of BS 1104. The BS 1104 and the BS 1106 may also use interference communication 1110 signals to configure a series of tests for UE 1108 to transmit one or more measurement signal Tx beams 1114 while BS 1104 receives an Rx beam 1112 to determine which Tx beams 1114 may interfere with Rx beams 1112 of BS 1104, and to what extent.

In some aspects, a measurement RS may be sent from an aggressor UE while a victim gNB or BS receives a transmission to measure actual interference. For example, the BS 1106 may be configured to receive Tx beams 1114 from the UE 1108 while the BS 1104 receives Rx beam 1112 from the wireless device 1102 to determine how such signals may interfere with various Rx beams transmitted to the BS 1104. For each Tx-Rx beam pair, the BS 1104 may be configured to measure 1122 an interference level to determine what Tx beams interfere with Rx beams sent to the BS 1104. An interference level may be measured in a plurality of ways, as discussed above. The BS 1104 may transmit 1125 at least some of the measurement results to the BS 1106. The measurement results may be used to populate a Tx-Rx matrix that indicates interference levels for each Tx-Rx combination, as described above. Such a matrix may be used in the future by BS 1104 or be transmitted to any other device, such as the BS 1106, to convey which Tx beam signals from a UE of the type of UE 1108 may interfere with Rx beam signals received by BS 1104.

The BS 1104 may identify 1132 an interference probability for each Rx beam of each Tx-Rx beam pair. Additionally, or alternatively, the BS 1104 may identify 1132 an interference probability for each Rx beam of each Tx-Rx beam pair where the Rx beam had a measured interference level that meets or exceeds a minimum threshold value, such as at least 10% or at least than 100 bytes per minute or at least 15% of a time window. Alternatively, or additionally, the BS 1106 may identify 1134 an interference probability for each Tx beam of each Tx-Rx beam pair. Alternatively, or additionally, the BS 1106 may identify 1134 an interference probability for each Tx beam of each Tx-Rx beam pair where the Tx beam had caused a measured interference level that meets or exceeds a minimum threshold value. The BS 1104 may transmit 1142 the interference probability of each Rx beam of each Tx-Rx beam pair to the BS 1106, and/or the BS 1106 may transmit 1142 the interference probability of each Tx beam of each Tx-Rx beam pair to the BS 1104.

If the interference probability of a particular UL beam (Tx beam 1114) of a neighbor UE (UE 1108) is high ˜80% in a time window with respect to an UL beam (Rx beam 1112) of a serving gNB (BS 1104), the serving gNB (BS 1104) may be configured to avoid scheduling an UL beam (Rx beam 1112) from a wireless device (wireless device 1102) that receives high interference from this particular neighbor UE's UL beam (Tx beam 1114) in a time window, similar to some of the above aspects. Additionally, or alternatively, if the interference probability of a particular UL beam (Tx beam 1114) of a neighbor gNB (BS 1106) is high (e.g., ˜80%) in a time window with respect to an UL beam (Rx beam 1112) of a serving gNB (BS 1104), the serving gNB (BS 1104) may be configured to transmit a signal of recommendation to the neighbor gNB (BS 1106) to request to reduce a neighbor gNB's UL beam usage probability to be less than a threshold for the conflicting beam (Tx beam 1114), such that the serving gNB (BS 1104) is able to schedule the conflicting UL (Rx beam 1112) without the neighbor gNB (BS 1106) using this interfering UL beam (Tx beam 1114) to transmit, similar to some of the above aspects.

The BS 1104 or the BS 1106, or both the BS 1104 and the BS 1106, may be configured to adjust 1152, 1154, a beam schedule to minimize a probability of interference based upon the measured interference levels for each Tx-Rx beam pair and the interference probability of the Rx beam, the interference probability of the Tx beam, or the interference probability of both beams of the Tx-Rx beam pairs. For example, the BS 1104 may be configured to avoid scheduling a conflicting Rx beam during time windows when the UE 1108 is known to be transmitting using a Tx beam having a high interference probability with respect to that Rx beam. Additionally, or alternatively, the BS 1104 may be configured to transmit 1162 a schedule notification to the BS 1106 to avoid transmitting one or more conflicting Tx beams during time windows when the BS 1104 is scheduled to receive an Rx beam 1112 that has a high interference probability with respect to the conflicting Tx beam 1114. Additionally, or alternatively, the BS 1106 may be configured to avoid scheduling one or more conflicting Tx beams during time windows when the BS 1104 may be scheduled to receive an Rx beam 1112 having a high interference probability with respect to the one or more conflicting Tx beams 1114. Additionally, or alternatively, the BS 1106 may be configured to transmit 1162 a schedule notification to the BS 1104 to avoid receiving one or more conflicting Rx beams from the wireless device 1102 during time windows when the BS 1106 may have a UE 1108 that is transmitting a Tx beam 1114 having a high interference probability with respect to the Rx beam 1112 received by the BS 1104. Adjusting a usage probability for a beam downwards may mean not using the beam at all (e.g., 0% usage probability), which may be suitable in situations where a usage probability for a conflicting beam is at or near 100%. Adjusting a usage probability for a beam upwards may mean using the beam during an entire time period (e.g., 100% usage probability), which may be suitable in situations where there is no measured interference between that beam and any other beam having a non-zero usage probability in a Tx-Rx matrix of measured interference levels.

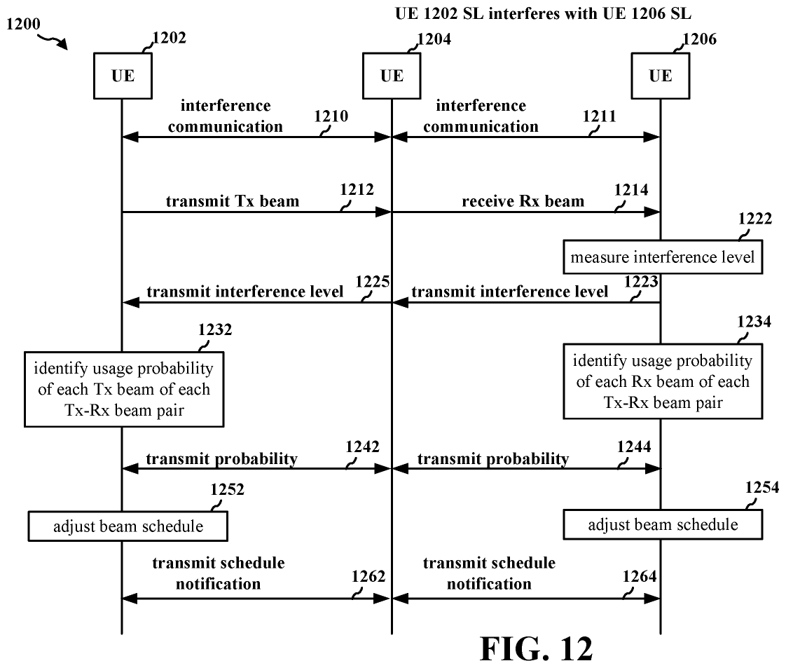

FIG. 12 shows a network connection flow diagram 1200 that illustrates an example of a UE 1202, a UE 1204, and a UE 1206, which each communicate using SL transmissions, some of which may interfere with one another. When the UE 1202 transmits a Tx beam 1212 to the UE 1204 via a SL transmission, the Tx beam 1212 may interfere with an Rx beam 1214 transmitted from the UE 1204 to the UE 1206 via a SL transmission. The network connection flow diagram 1200 illustrates a UE SL system where usage probability of UE beam assistance may be transmitted from a UE to a neighbor UE using a SL transmission.

While UE 1202 and UE 1206 are shown as using UE 1204 as an intermediary to pass communications to one another, UE 1202 and UE 1206 may be configured to pass communications directly to one another without using UE 1204 as an intermediary via another SL connection. For example, UE 1202 and UE 1206 may be configured to pass interface communications 1210 and 1211 directly to one another without using UE 1204 as an intermediary, and UE 1202 and UE 1206 may be configured to transmit 1242, 1244, probabilities directly to one another without using UE 1204 as an intermediary.

To determine what possible Tx beams 1212 from UE 1202 may interfere with an Rx beam 1214 sent to UE 1206, UE 1202 may be configured to communicate with UE 1206 either directly with one another or via UE 1204 as an intermediary. That is, UE 1202 may use an interface communication 1210 with UE 1204, and UE 1206 may use an interface communication 1211 with UE 1204 to determine what SL Tx beams from UE 1202 may interfere with Rx beams sent to UE 1206. For example, the UE 1202 may transmit a list of Tx beams that the UE 1202 is capable of transmitting to the UE 1206, the UE 1206 may transmit a list of Rx beams that the UE 1206 is capable of receiving, the UE 1206 may transmit a Tx-Rx matrix of known interference levels such that UE 1202 knows what Tx beams may interfere with Rx beams of UE 1206, or the UE 1206 may transmit a Tx-Rx matrix of known interference probabilities such that UE 1202 knows what Tx beams have a high probability of creating an interference with Rx beams of UE 1206. The UE 1202 and the UE 1206 may also use interference communication 1210, 1211 signals to configure a series of tests for UE 1202 to transmit one or more measurement RS Tx beams 1212 while UE 1206 receives an Rx beam 1214 to determine which Tx beams 1212 may interfere with Rx beams 1214 of UE 1206, and to what extent.

In other words, measurement signals may be sent from an aggressor UE while a victim UE receives a signal to measure actual interference. For example, a UE 1202 may be configured to transmit a measurement RS for each possible Tx-Rx beam pair between a UE 1202 and a UE 1206, respectively. For each Tx-Rx beam pair, the UE 1206 may be configured to measure 1222 an interference level to determine what Tx beams from the UE 1202 interfere with Rx beams sent to the UE 1206, and/or to what extent. An interference level may be measured in a plurality of ways, as explained above. The UE 1206 may transmit 1223, 1225 at least some of the measurement results to the UE 1202, either directly or via the intermediary UE 1204 device.

The measurement results may be used to populate a Tx-Rx matrix that indicates interference levels for each Tx-Rx combination. The Tx-Rx matrix may be saved as a matrix template for any UEs of the same type as UE 1202 and UE 1206, respectively, or which may be configured to transmit and receive along the same frequency spectrums as UE 1202 and UE 1206, respectively.

The UE 1202 may identify 1232 a usage probability for each Tx beam of each Tx-Rx beam pair. Additionally, or alternatively, the UE 1206 may identify 1234 a usage probability for each Rx beam of each Tx-Rx beam pair where the Rx beam had a measured interference level that meets or exceeds a minimum threshold, such as at least 10% or at least 100 bytes per minute or at least 15% of a time window. Alternatively, or additionally, the UE 1202 may identify 1232 a usage probability for each Tx beam of each Tx-Rx beam pair. Alternatively, or additionally, the UE 1202 may identify 1232 a usage probability for each Tx beam of each Tx-Rx beam pair where the Tx beam had caused a measured interference level that meets or exceeds a minimum threshold. The UE 1206 may transmit 1244 the usage probability of each Rx beam of each Tx-Rx beam pair to the UE 1202, and/or the UE 1202 may transmit 1242 the usage probability of each Tx beam of each Tx-Rx beam pair to the UE 1206. The usage probability may be transmitted directly between the UE 1202 and the UE 1206 via another SL connection.

If the usage probability of a particular beam is high in a time window, a neighbor UE may be configured to avoid using a non-compatible or high interference beam in the reverse diction on the resources, or by a negotiation between UEs. For example, the UE 1202 may indicate to its neighbor UE 1206 via SL a usage probability of each of its SL forward link/reverse link beams, or vice versa. Such situations may occur for mode 2 resource allocation which may not have any gNB controlled scheduling. Where a neighbor UE 1202's SL Tx beam 1212 (e.g., beam #1) to UE 1204 may interfere with a UE 1204 transmitting a SL Rx beam 1214 (e.g., beam #3) to UE 1216, the UE 1206 may adjust 1254 its beam schedule to change its own beam (e.g., beam #3) to some other beam (e.g., beam #2) which the neighbor UE 1202's SL Tx beam 1212 (e.g., beam #1) has a low impact (i.e., the interference level for that Tx-Rx pair is below a threshold level). Where a neighbor UE 1202's SL Tx beam 1212 (e.g., beam #1) to UE 1204 may interfere with a UE 1204 transmitting a SL Rx beam 1214 (e.g., beam #3) to UE 1216, the UE 1206 may adjust 1254 its beam schedule to transmit 1264 a schedule notification to the UE 1204 which may then be transmitted 1262 by the UE 1204 to the UE 1202 to instruct the UE 1202 to reduce its usage probability of beam #1 for a time window. The UE 1206 may directly transmit 1264 the schedule notification to the UE 1202 via another SL beam.

With the usage probability information, the UE 1202 may be able to adjust 1252 a beam schedule for the UE 1202 or the UE 1206, or the UE 1206 may be able to adjust 1254 a beam schedule for the UE 1202 or the UE 1206. For example, if a victim UE (e.g., UE 1206) indicates (e.g., by transmitting 1244, 1242 a usage probability) a usage probability of SL beam #2 is 80% in a time window, the aggressor UE (e.g., UE 1202) may be configured to avoid using a non-compatible SL beam #1 (e.g., Tx beam 1212) which may cause a high interference to SL beam #2 (e.g., Rx beam 1214) in the reverse direction on the victim UE's communications. Alternatively, if the victim UE (e.g., UE 1206) indicates a usage probability of UL beam #2 is 80% in a time window, the aggressor UE (e.g., UE 1202) may transmit 1262, 1264 a schedule notification or a signaling of a recommendation to the victim UE (e.g., UE 1206) to reduce SL beam #2 (e.g., Rx beam 1214) usage probability such that its SL beam #1 (e.g., Tx beam 1212) may be scheduled.

The UE 1202 or the UE 1206, or both the UE 1202 and the UE 1206, may be configured to adjust 1252, 1254, a beam schedule to minimize a probability of interference based upon the measured interference levels for each Tx-Rx beam pair and the usage probability of the Rx beam, the usage probability of the Tx beam, or the usage probability of both beams of the Tx-Rx beam pairs. For example, the UE 1206 may be configured to avoid scheduling a conflicting Rx beam during time windows when the UE 1202 is known to have a high usage probability of one or more Tx beams that interferes with that Rx beam. Additionally, or alternatively, the UE 1206 may be configured to transmit 1264, 1262 a schedule notification to the UE 1202 to avoid transmitting one or more conflicting Tx beams during time windows when the UE 1206 has a high usage probability to receive a conflicting Rx beam. Additionally, or alternatively, the UE 1202 may be configured to avoid scheduling one or more conflicting Tx beams during time windows when the UE 1206 may have a high usage probability for an Rx that is interfered with by the one or more conflicting Tx beams. Additionally, or alternatively, the UE 1202 may be configured to transmit 1262, 1264 a schedule notification to the UE 1206 to avoid transmitting one or more conflicting Rx beams during time windows when the UE 1202 may have a high usage probability for a Tx that interferes with the one or more conflicting Rx beams. Adjusting a usage probability for a beam downwards may mean not using the beam at all (e.g., 0% usage probability). Adjusting a usage probability for a beam upwards may mean using the beam all the time (e.g., 100% usage probability).

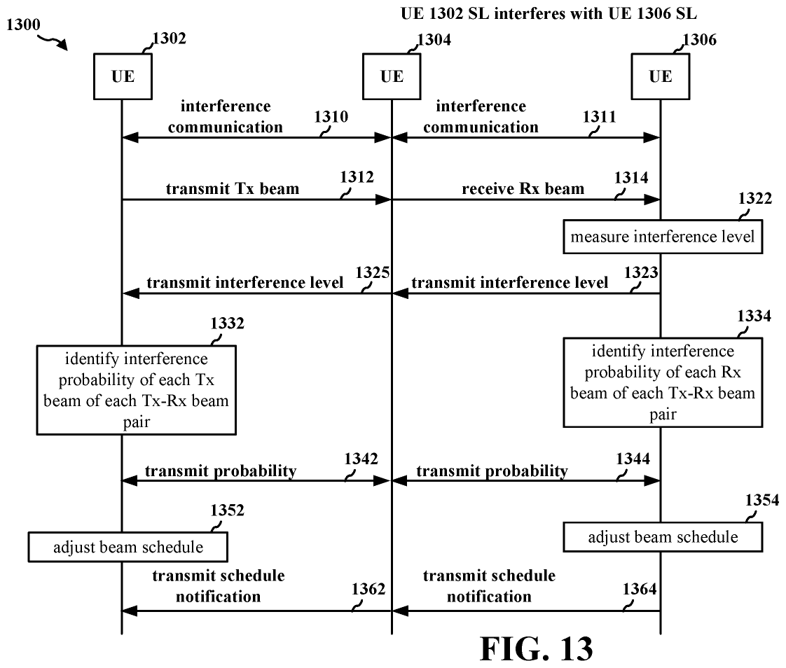

FIG. 13 shows a network connection flow diagram 1300 that illustrates an example of a UE 1302, a UE 1304, and a UE 1306, which each communicate using SL transmissions, some of which may interfere with one another. When the UE 1302 transmits a Tx beam 1312 to the UE 1304 via a SL transmission, the Tx beam 1312 may interfere with an Rx beam 1314 transmitted from the UE 1304 to the UE 1306 via a SL transmission. The network connection flow diagram 1300 illustrates a UE SL system where interference probability of UE beam assistance may be transmitted from a UE to a neighbor UE using a SL transmission.

While UE 1302 and UE 1306 are shown as using UE 1304 as an intermediary to pass communications to one another, UE 1302 and UE 1306 may be configured to pass communications directly to one another without using UE 1304 as an intermediary via another SL connection. For example, UE 1302 and UE 1306 may be configured to pass interface communications 1310 and 1311 directly to one another without using UE 1304 as an intermediary, and UE 1302 and UE 1306 may be configured to transmit 1342, 1344, probabilities directly to one another without using UE 1304 as an intermediary.

To determine what possible Tx beams 1312 from UE 1302 may interfere with an Rx beam 1314 sent to UE 1306, UE 1302 may be configured to communicate with UE 1306 either directly with one another or via UE 1304 as an intermediary. That is, UE 1302 may use an interface communication 1310 with UE 1304, and UE 1306 may use an interface communication 1311 with UE 1304 to determine what SL Tx beams from UE 1302 may interfere with Rx beams sent to UE 1306. For example, the UE 1302 may transmit a list of Tx beams that the UE 1302 is capable of transmitting to the UE 1306, the UE 1306 may transmit a list of Rx beams that the UE 1306 is capable of receiving to the UE 1302, the UE 1306 may transmit a Tx-Rx matrix of known interference levels to the UE 1302 such that UE 1302 knows what Tx beams may interfere with Rx beams of UE 1306, or the UE 1306 may transmit a Tx-Rx matrix of known interference probabilities to the UE 1302 such that UE 1302 knows what Tx beams have a high probability of creating an interference with Rx beams of UE 1306. The UE 1302 and the UE 1306 may also use interference communication 1310, 1311 signals to set up a series of tests for UE 1302 to transmit one or more measurement RS Tx beams 1312 while UE 1306 receives an Rx beam 1314 to determine which Tx beams 1312 may interfere with Rx beams 1314 of UE 1306, and to what extent.

In other words, measurement signals may be sent from an aggressor UE while a victim UE receives a signal to measure actual interference. For example, a UE 1302 may be configured to transmit a measurement RS for each possible Tx-Rx beam pair between a UE 1302 and a UE 1306, respectively. For each Tx-Rx beam pair, the UE 1306 may be configured to measure 1322 an interference level to determine what Tx beams from the UE 1302 interfere with Rx beams sent to the UE 1306, and/or to what extent. An interference level may be measured in a plurality of ways, as explained above. The UE 1306 may transmit 1323, 1325 at least some of the measurement results to the UE 1302, either directly or via the intermediary UE 1304 device.

The measurement results may be used to populate a Tx-Rx matrix that indicates interference levels for each Tx-Rx combination. The Tx-Rx matrix may be saved as a matrix template for any UE's of the same type as UE 1302 and UE 1306, respectively, or which may be configured to transmit and receive along the same frequency spectrums as UE 1302 and UE 1306, respectively.

The UE 1302 may identify 1332 an interference probability for each Tx beam of each Tx-Rx beam pair. Additionally, or alternatively, the UE 1306 may identify 1334 an interference probability for each Rx beam of each Tx-Rx beam pair where the Rx beam had a measured interference level that meets or exceeds a minimum threshold, such as at least 10% or at least 100 bytes per minute or at least 15% of a time window. Alternatively, or additionally, the UE 1302 may identify 1332 an interference probability for each Tx beam of each Tx-Rx beam pair. Alternatively, or additionally, the UE 1302 may identify 1332 an interference probability for each Tx beam of each Tx-Rx beam pair where the Tx beam had caused a measured interference level that meets or exceeds a minimum threshold. The UE 1306 may transmit 1344 the interference probability of each Rx beam of each Tx-Rx beam pair to the UE 1302, and/or the UE 1302 may transmit 1342 the interference probability of each Tx beam of each Tx-Rx beam pair to the UE 1306. The interference probability may be transmitted directly between the UE 1302 and the UE 1306 via another SL connection.

If the interference probability of a particular beam is high in a time window, a neighbor UE may be configured to avoid using a non-compatible or high interference beam in the reverse diction on the resources, or by a negotiation between UEs. For example, the UE 1302 may indicate to its neighbor UE 1306 via SL an interference probability of each of its SL forward link/reverse link beams, or vice versa. Such situations may occur for mode 2 resource allocation which may not have any gNB controlled scheduling. Where a neighbor UE 1302's SL Tx beam 1312 (e.g., beam #1) to UE 1304 may have a high interference probability with a SL Rx beam 1314 (e.g., beam #3) of a UE 1304 to UE 1316, the UE 1306 may adjust 1354 its beam schedule to change its own beam (e.g., beam #3) to some other beam (e.g., beam #2) which the neighbor UE 1302's SL Tx beam 1312 (e.g., beam #1) has a low impact (e.g., the interference probability for that Tx-Rx pair is below a threshold level). Where a neighbor UE 1302's SL Tx beam 1312 (e.g., beam #1) to UE 1304 may have a high interference probability with a SL Rx beam 1314 (e.g., beam #3) of a UE 1304 transmitting to UE 1316, the UE 1306 may adjust 1354 its beam schedule to transmit 1364 a schedule notification to the UE 1304 which may then be transmitted 1362 by the UE 1304 to the UE 1302 to instruct the UE 1302 to reduce its usage probability of beam #1 for a time window. The UE 1306 may directly transmit 1364 the schedule notification to the UE 1302 via another SL beam.

With the usage probability information, the UE 1302 may be able to adjust 1352 a beam schedule for the UE 1302 or the UE 1306, or the UE 1306 may be able to adjust 1354 a beam schedule for the UE 1302 or the UE 1306. For example, if the victim UE (e.g., UE 1306) indicates (e.g., by transmitting 1344, 1342 an interference probability) an interference probability of SL beam #2 is 80% in a time window with respect to a SL beam #1 (e.g., Tx beam 1312) from the aggressor UE (e.g., UE 1302), the aggressor UE (e.g., UE 1302) may be configured to avoid using a non-compatible SL beam #1 (e.g., Tx beam 1312) which may have a high interference probability with SL beam #2 (e.g., Rx beam 1314) in the reverse direction on the victim UE's communications. Alternatively, if the victim UE (e.g., UE 1306) indicates that an interference probability of UL beam #2 is 80% in a time window with respect to UL beam #1 of the aggressor UE (e.g., UE 1302), the aggressor UE (e.g., UE 1302) may transmit 1362, 1364 a schedule notification or a signaling of a recommendation to the victim UE (e.g., UE 1306) to reduce SL beam #2 (e.g., Rx beam 1314) usage probability so that its SL beam #1 (e.g., Tx beam 1312) may be scheduled.

The UE 1302 or the UE 1306, or both the UE 1302 and the UE 1306 may be configured to adjust 1352, 1354, a beam schedule to minimize a probability of interference based upon the measured interference levels for each Tx-Rx beam pair and the interference probability of the Rx beam, the interference probability of the Tx beam, or the interference probability of both beams of the Tx-Rx beam pairs. The UE 1306 may be configured to avoid scheduling a conflicting Rx beam during time windows when the UE 1302 is known to have a high usage probability of one or more Tx beams that interferes with that Rx beam. The UE 1306 may be configured to transmit 1364, 1362 a schedule notification to the UE 1302 to avoid transmitting one or more conflicting Tx beams during time windows when the UE 1306 has a high usage probability to receive a conflicting Rx beam. The UE 1302 may be configured to avoid scheduling one or more conflicting Tx beams during time windows when the UE 1306 may have a high usage probability for an Rx that is interfered with by the one or more conflicting Tx beams. The UE 1302 may be configured to transmit 1362, 1364 a schedule notification to the UE 1306 to avoid transmitting one or more conflicting Rx beams during time windows when the UE 1302 may have a high usage probability for a Tx that interferes with the one or more conflicting Rx beams. Adjusting a usage probability for a beam downwards may mean not using the beam at all (e.g., 0% usage probability). Adjusting a usage probability for a beam upwards may mean using the beam all the time (e.g., 100% usage probability).

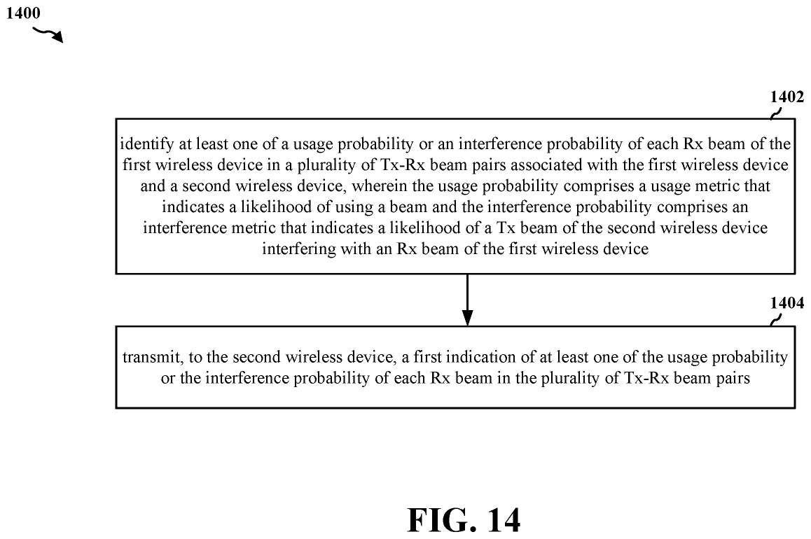

FIG. 14 is a flowchart 1400 of a method of wireless communication at a wireless device. The method may be performed by any wireless device, such as the UE 104, the BS 102, the BS 504, the UE 602, the BS 604, the UE 702, the BS 704, the UE 802, the BS 804, the UE 902, the BS 904, the BS 1004, the BS 1104, the UE 1206, the UE 1204, the UE 1306, the UE 1304, the apparatus 1804, the network entity 1802, or the network entity 1902. The method may enable a wireless device to minimize potential interference with an Rx beam from a Tx beam by adjusting at least one beam schedule.

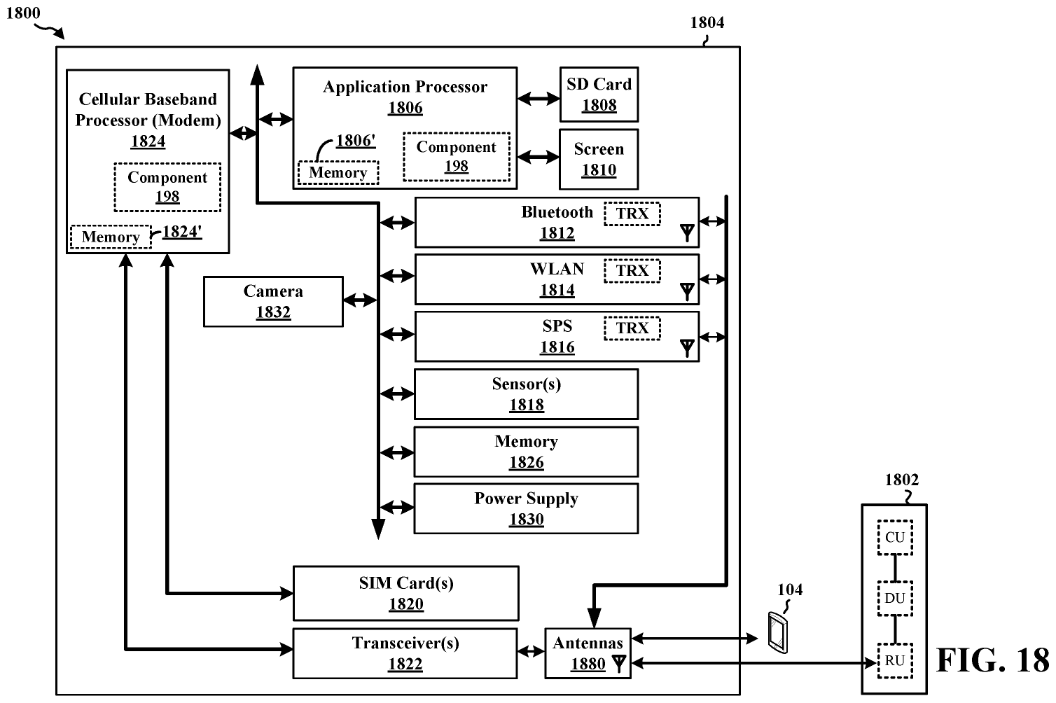

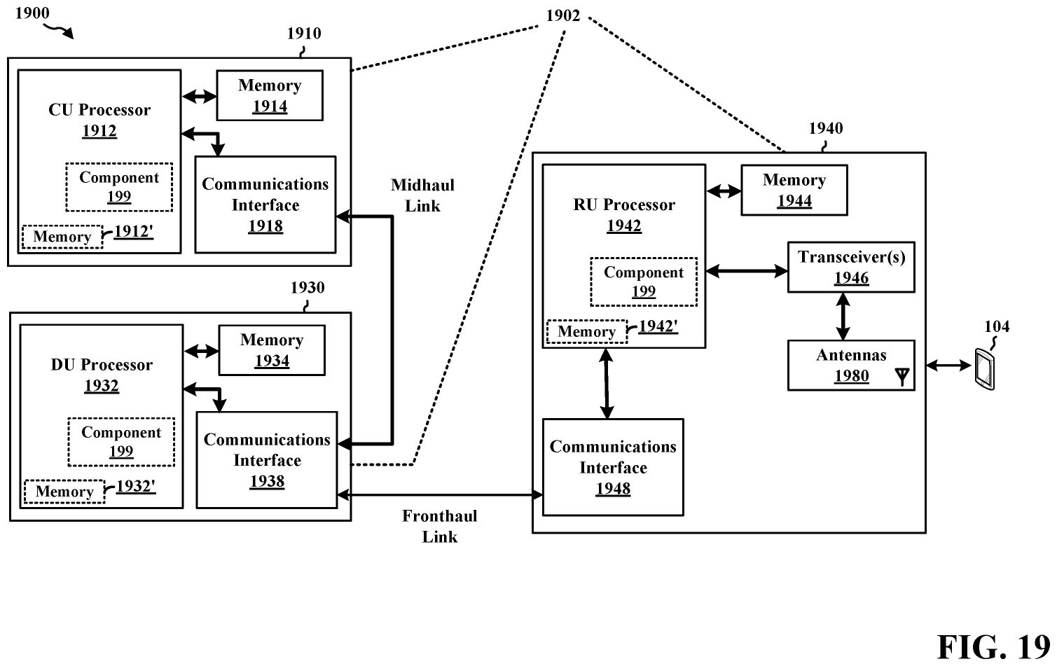

At 1402, a first wireless device may identify a usage probability of each Rx beam of the first wireless device in the plurality of Tx-Rx beam pairs associated with the first wireless device and the second wireless device, where the usage probability may include a usage metric that indicates a likelihood of using a beam. For example, the BS 404 in FIG. 4 may identify 432 a usage probability of each Rx beam 412 of the BS 404 the plurality of Tx-Rx beam pairs between the BS 404 and the BS 406. Alternatively, the first wireless device may identify an interference probability of each Rx beam of the first wireless device in the plurality of Tx-Rx beam pairs associated with the first wireless device and the second wireless device, where the interference probability may include an interference metric that indicates a likelihood of a Tx beam of the second wireless device interfering with an Rx beam of the first wireless device. For example, the BS 504 in FIG. 5 may identify 532 an interference probability of each Rx beam 412 of the BS 404 the plurality of Tx-Rx beam pairs between the BS 404 and the BS 406. Further, 1402 may be performed by the probability interface component 198 in FIG. 18 or the probability interface component 199 in FIG. 19.

At 1404, the first wireless device may transmit, to the second wireless device, a first indication of the usage probability of each Rx beam in the plurality of Tx-Rx beam pairs. For example, the BS 404 in FIG. 4 may transmit 442, to the BS 406, a first indication of the identified 432 usage probability of each Rx beam 412 in the plurality of Tx-Rx beam pairs between the BS 404 and the BS 406. Alternatively, the first wireless device may transmit, to the second wireless device, a first indication of the interference probability of each Rx beam in the plurality of Tx-Rx beam pairs. For example, the BS 504 in FIG. 5 may transmit 542, to the BS 506, a first indication of the identified 532 interference probability of each Rx beam 512 in the plurality of Tx-Rx beam pairs between the BS 504 and the BS 506. Further, 1404 may be performed by the probability interface component 198 in FIG. 18 or the probability interface component 199 in FIG. 19.

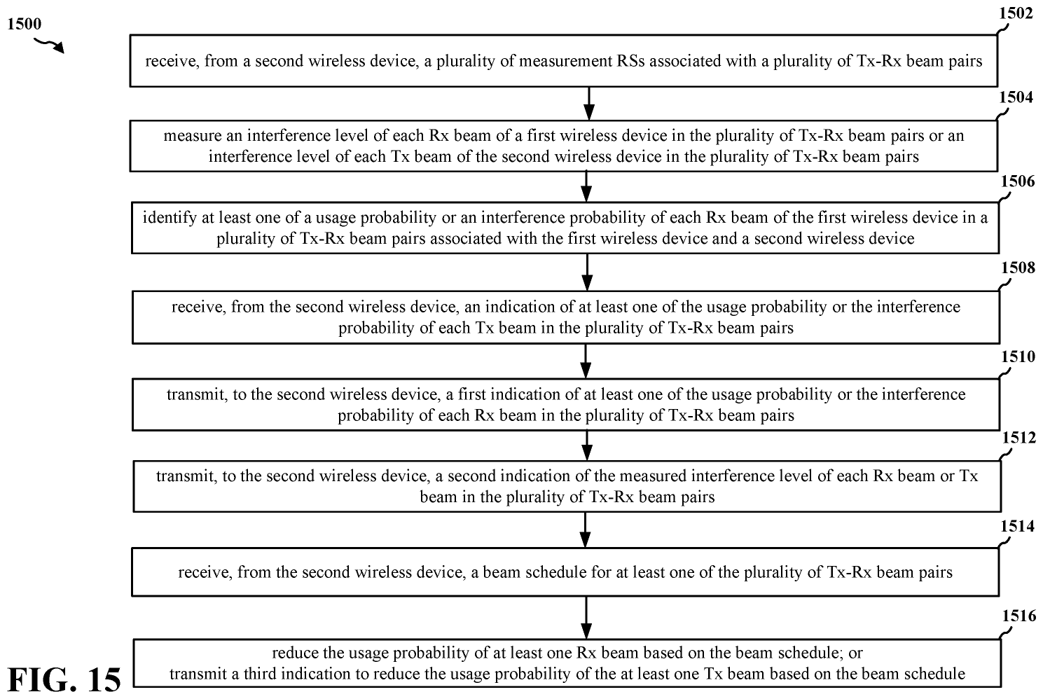

FIG. 15 is a flowchart 1500 of a method of wireless communication at a wireless device. The method may be performed by any wireless device, such as the UE 104, the BS 102, the BS 504, the UE 602, the BS 604, the UE 702, the BS 704, the UE 802, the BS 804, the UE 902, the BS 904, the BS 1004, the BS 1104, the UE 1206, the UE 1204, the UE 1306, the UE 1304, the apparatus 1804, the network entity 1802, or the network entity 1902. The method may improve a wireless device's ability to minimize potential interference with an Rx beam from a Tx beam by adjusting at least one beam schedule.

At 1502, a first wireless device may receive, from a second wireless device, a plurality of measurement RSs associated with a plurality of Tx-Rx beam pairs. For example, the BS 404 in FIG. 4 may receive, from the BS 406, a plurality of measurement RSs in the form of Tx beams 414 transmitted from BS 406. The plurality of measurement RSs in the form of Tx beams 414 may be associated with the plurality of Tx-Rx beam pairs between BS 404 and BS 406. At least one of the measured 422 interference levels for each of the plurality of Tx-Rx beam pairs between BS 404 and BS 406 may be based on the plurality of Tx beams 414 transmitted from BS 406. Further, 1502 may be performed by the probability interface component 198 in FIG. 18 or the probability interface component 199 in FIG. 19.

At 1504, the first wireless device may measure an interference level of each Rx beam of the first wireless device in the plurality of Tx-Rx beam pairs or an interference level of each Tx beam of the second wireless device in the plurality of Tx-Rx beam pairs. For example, the BS 404 in FIG. 4 may measure an interference level of the Rx beam 412 of the BS 404 for each of a plurality of Tx-Rx beam pairs associated with the BS 404 and the BS 406. Alternatively, in another aspect, the BS 404 in FIG. 4 may measure an interference level of the Tx beam 414 of the BS 406 for each of a plurality of Tx-Rx beam pairs associated with the BS 404 and the BS 406. Further, 1504 may be performed by the probability interface component 198 in FIG. 18 or the probability interface component 199 in FIG. 19.

At 1506, the first wireless device may identify at least one of a usage probability or an interference probability of each Rx beam of the first wireless device in a plurality of Tx-Rx beam pairs associated with the first wireless device and a second wireless device. For example, the BS 404 in FIG. 4 may identify 432 a usage probability of each Rx beam 412 of the BS 404 for each Tx-Rx beam pair associated with the BS 404 and the BS 406. Alternatively, in another aspect, the BS 504 in FIG. 5 may identify 532 an interference probability of each Rx beam 512 of the BS 504 for each Tx-Rx beam pair associated with the BS 504 and the BS 506. Further, 1506 may be performed by the probability interface component 198 in FIG. 18 or the probability interface component 199 in FIG. 19.

At 1508, the first wireless device may receive, from the second wireless device, an indication of at least one of the usage probability or the interference probability of each Tx beam in the plurality of Tx-Rx beam pairs. For example, the BS 404 in FIG. 4 may receive, from the BS 406, an indication of the identified 434 usage probability of each Tx beam 414 in the plurality of Tx-Rx beam pairs between the BS 404 and the BS 406. The second indication of the measured 422 interference level of each Tx beam 414 may be associated with the received indication of the of the identified 434 usage probability of each Tx beam 414 in the plurality of Tx-Rx beam pairs between the BS 404 and the BS 406. Alternatively, in another aspect, the BS 504 in FIG. 5 may receive, from the BS 506, an indication of the identified 534 interference probability of each Tx beam 514 in the plurality of Tx-Rx beam pairs between the BS 504 and the BS 506. The second indication of the measured 522 interference level of each Tx beam 514 may be associated with the received indication of the of the identified 534 usage probability of each Tx beam 514 in the plurality of Tx-Rx beam pairs between the BS 504 and the BS 506. Further, 1508 may be performed by the probability interface component 198 in FIG. 18 or the probability interface component 199 in FIG. 19.

At 1510, the first wireless device may transmit, to the second wireless device, a first indication of at least one of the usage probability or the interference probability of each Rx beam in the plurality of Tx-Rx beam pairs. For example, the BS 404 in FIG. 4 may transmit 442, to the BS 406, an indication of a usage probability of each Rx beam of each Tx-Rx beam pair associated with the BS 404 and the BS 406. Alternatively, in another aspect, the BS 504 in FIG. 5 may transmit 542, to the BS 506, an indication of an interference probability of each Rx beam of each Tx-Rx beam pair associated with the BS 504 and the BS 506. Further, 1510 may be performed by the probability interface component 198 in FIG. 18 or the probability interface component 199 in FIG. 19.

At 1512, the first wireless device may transmit, to the second wireless device, a second indication of the measured interference level of each Rx beam or Tx beam in the plurality of Tx-Rx beam pairs. For example, the BS 404 in FIG. 4 may transmit 424, to the BS 406, a second indication of the measured 422 interference level of each Rx beam 412 in the plurality of Tx-Rx beam pairs between the BS 404 and the BS 406. Alternatively, the BS 404 in FIG. 4 may transmit 424, to the BS 406, a second indication of the measured 422 interference level of each Tx beam 414 in the plurality of Tx-Rx beam pairs between the BS 404 and the BS 406. Further, 1512 may be performed by the probability interface component 198 in FIG. 18 or the probability interface component 199 in FIG. 19.

At 1514, the first wireless device may receive, from the second wireless device, a beam schedule for at least one of the plurality of Tx-Rx beam pairs. For example, the BS 404 in FIG. 4 may receive, from the BS 406, a transmitted 862 beam schedule notification for at least one of the Tx-Rx beam pairs. The BS 406 may transmit 442 an increased usage probability for the BS 406 to use a Tx beam 414 that interferes with the Rx beam 412. Further, 1514 may be performed by the probability interface component 198 in FIG. 18 or the probability interface component 199 in FIG. 19.

At 1516, the first wireless device may reduce the usage probability of at least one Rx beam based on the beam schedule or transmit a third indication to reduce the usage probability of the at least one Tx beam based on the beam schedule. For example, the BS 404 may reduce the usage probability of at least one Rx beam 412 associated with at least one of the plurality of Tx-Rx beam pairs by adjusting 452 a beam schedule of the Rx beam 412 based on the transmitted 442 increased usage probability. Alternatively, at 1516, the BS 404 may transmit 462 a schedule notification to the BS 406 to reduce the usage probability of a Tx beam 414 that interferes with the Rx beam 412 based on an adjustment 452 of a beam schedule of the Tx beam 414. Further, 1516 may be performed by the probability interface component 198 in FIG. 18 or the probability interface component 199 in FIG. 19.

In some aspects, the interference level for each of the plurality of Tx-Rx beam pairs may be based on inter-node CLI. For example, the measured 422 interference level of FIG. 4 for each of the plurality of Tx-Rx beam pairs between the BS 404 and the BS 406 may be based on inter-node CLI.

In some aspects, the usage probability corresponds to a first probability over a first time window, and the interference probability corresponds to a second probability over a second time window. For example, the identified 432 usage probability of FIG. 4 may correspond to a first probability over a first time window, and the identified 532 interference probability of FIG. 5 may correspond to a second probability over a second time window.

In some aspects, the usage probability is associated with a usage threshold, and the interference probability is associated with an interference threshold. For example, the identified 432 usage probability of FIG. 4 may be associated with a usage threshold, and the identified 532 interference probability of FIG. 5 may be associated with an interference threshold.

In some aspects, the first indication of the at least one of the usage probability or the interference probability of each Rx beam in the plurality of Tx-Rx beam pairs is associated with at least one of the usage probability being greater than the usage threshold or the interference level being greater than the interference threshold. For example, the identified 432 usage probability of FIG. 4 of each Rx beam 412 in the plurality of Tx-Rx beam pairs between BS 404 and BS 406 may be associated with the identified 432 usage probability being greater than the usage threshold. Alternatively, the identified 532 interference probability of FIG. 5 of each Rx beam 512 in the plurality of Tx-Rx beam pairs between BS 504 and BS 506 may be associated with the identified 532 usage probability being greater than the usage threshold.

In some aspects, the first wireless device is a first BS or a first UE and the second wireless device is a second BS or a second UE. For example, BS 404 in FIG. 4 is a BS, UE 802 in FIG. 8 is a UE, BS 406 in FIG. 4 is a BS, and UE 808 in FIG. 8 is a UE.

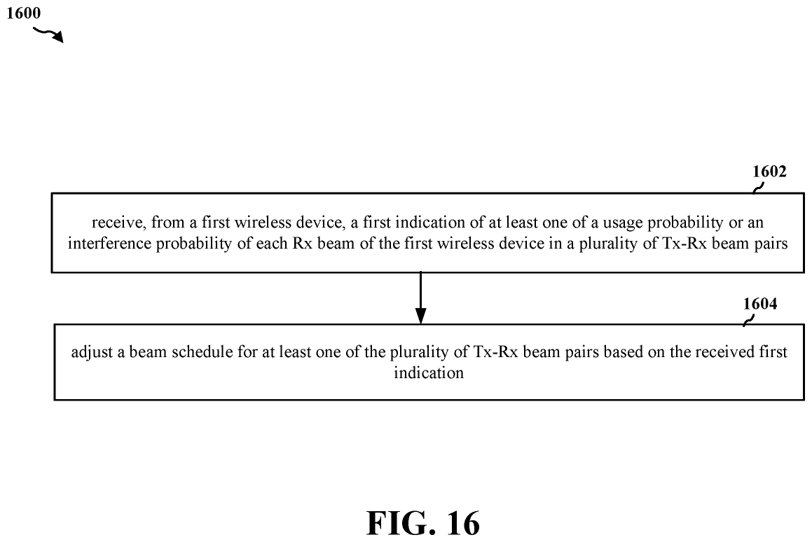

FIG. 16 is a flowchart 1600 of a method of wireless communication at a wireless device. The method may be performed by any wireless device, such as the UE 104, the BS 102, the BS 506, the BS 606, the BS 706, the BS 806, the BS 906, the BS 1006, the BS 1106, the UE 1206, the UE 1202, the UE 1204, the UE 1302, the UE 1304, the apparatus 1804, the network entity 1802, or the network entity 1902. The method may enable a wireless device to minimize potential interference with an Rx beam from a Tx beam by adjusting at least one beam schedule.

At 1602, a second wireless device may receive, from a first wireless device, a first indication of a usage probability of each Rx beam of the first wireless device in a plurality of Tx-Rx beam pairs. For example, the BS 406 in FIG. 4 may receive a transmission 442, from the BS 404, a first indication of the identified 432 usage probability of each Rx beam 412 in the plurality of Tx-Rx beam pairs between the BS 404 and the BS 406. Alternatively, at 1602, a second wireless device may receive, from a first wireless device, a first indication of an interference probability of each Rx beam of the first wireless device in a plurality of Tx-Rx beam pairs. For example, the BS 506 in FIG. 5 may receive a transmission 542, from the BS 504, a first indication of the identified 532 interference probability of each Rx beam 512 in the plurality of Tx-Rx beam pairs between the BS 504 and the BS 506. Further, 1602 may be performed by the probability interface component 198 in FIG. 18 or the probability interface component 199 in FIG. 19.

At 1604, the second wireless device may adjust a beam schedule for the plurality of Tx-Rx beam pairs based on the received first indication. For example, the BS 406 in FIG. 4 may adjust 454 a beam schedule for the plurality of Tx-Rx beam pairs based on the received first indication of the identified 432 usage probability of each Rx beam 412 in the plurality of Tx-Rx beam pairs between the BS 404 and the BS 406. Alternatively, the BS 506 in FIG. 5 may adjust 554 a beam schedule for the plurality of Tx-Rx beam pairs based on the first indication of the identified 532 interference probability of each Rx beam 512 in the plurality of Tx-Rx beam pairs between the BS 504 and the BS 506. Further, 1604 may be performed by the probability interface component 198 in FIG. 18 or the probability interface component 199 in FIG. 19.

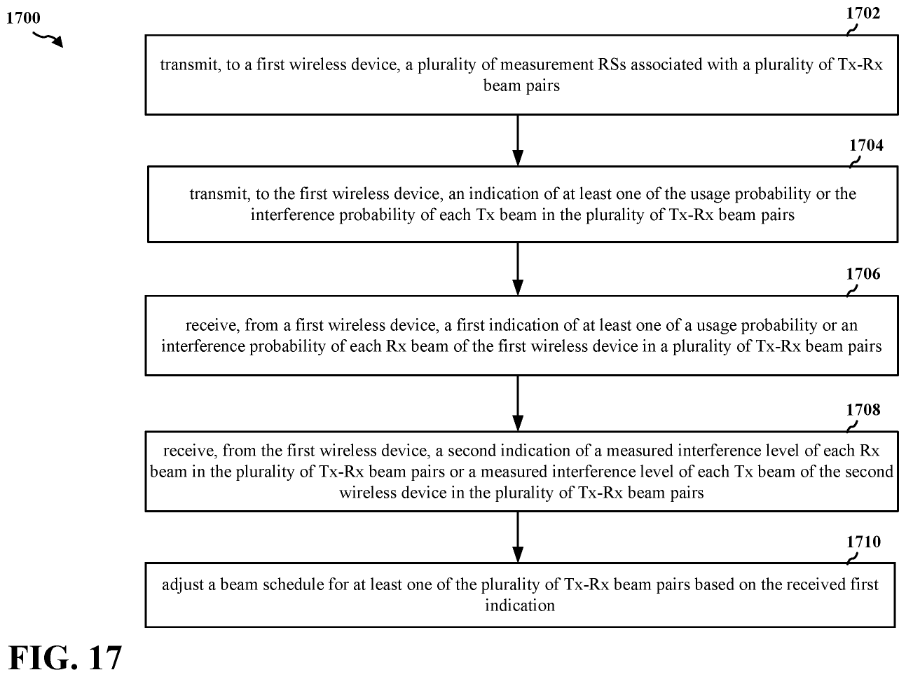

FIG. 17 is a flowchart 1700 of a method of wireless communication at a wireless device. The method may be performed by any wireless device, such as the UE 104, the BS 102, the BS 504, the UE 602, the BS 604, the UE 702, the BS 704, the UE 802, the BS 804, the UE 902, the BS 904, the BS 1004, the BS 1104, the UE 1206, the UE 1204, the UE 1306, the UE 1304, the apparatus 1804, the network entity 1802, or the network entity 1902. The method may improve a wireless device's ability to minimize potential interference with an Rx beam from a Tx beam by adjusting at least one beam schedule.

At 1702, a second wireless device may transmit, to a first wireless device, a plurality of measurement RSs associated with a plurality of Tx-Rx beam pairs. For example, the BS 406 may transmit to the BS 404 a plurality of measurement RSs in the form of Tx beams 414 associated with the plurality of Tx-Rx beam pairs between the BS 404 and the BS 406. The second indication of the measured 422 interference level of each Rx beam 412 or each Tx beam of the plurality of Tx-Rx beam pairs between the BS 404 and the BS 406 may be based on the plurality of measurement RSs in the form of Tx beams 414 transmitted from the BS 406. Further, 1702 may be performed by the probability interface component 198 in FIG. 18 or the probability interface component 199 in FIG. 19.

At 1704, a second wireless device may transmit, to the first wireless device, an indication of at least one of the usage probability or the interference probability of each Tx beam in the plurality of Tx-Rx beam pairs. For example, the BS 406 may transmit 442 to the BS 404 an indication of the identified 434 usage probability of each Tx beam 414 in the plurality of Tx-Rx beam pairs between the BS 404 and the BS 406. The second indication of the measured 422 interference level of each Tx beam 414 may be associated with the transmitted 442 indication of the identified 434 usage probability of each Tx beam 414 in the plurality of Tx-Rx beam pairs between the BS 404 and the BS 406. Alternatively, in another aspect, the BS 506 may transmit 542 to the BS 504 an indication of the identified 534 interference probability of each Tx beam 514 in the plurality of Tx-Rx beam pairs between the BS 504 and the BS 506. The second indication of the measured 522 interference level of each Tx beam 514 may be associated with the transmitted 542 indication of the identified 534 usage probability of each Tx beam 514 in the plurality of Tx-Rx beam pairs between the BS 504 and the BS 506. Further, 1704 may be performed by the probability interface component 198 in FIG. 18 or the probability interface component 199 in FIG. 19.

At 1706, a second wireless device may receive, from a first wireless device, a first indication of at least one of a usage probability or an interference probability of each Rx beam of the first wireless device in a plurality of Tx-Rx beam pairs. For example, the BS 406 in FIG. 4 may receive a transmission 424, from the BS 404, an indication of the identified 432 usage probability of each Rx beam 412 of the BS 404 of each Tx-Rx beam pair associated with the BS 404 and the BS 406. Alternatively, in another aspect, the BS 506 in FIG. 5 may receive a transmission 542, from the BS 504, an indication of the identified 532 interference probability of each Rx beam 512 of the BS 504 of each Tx-Rx beam pair associated with the BS 504 and the BS 506. Further, 1706 may be performed by the probability interface component 198 in FIG. 18 or the probability interface component 199 in FIG. 19.

At 1708, a second wireless device may receive, from the first wireless device, a second indication of a measured interference level of each Rx beam in the plurality of Tx-Rx beam pairs or a measured interference level of each Tx beam of the second wireless device in the plurality of Tx-Rx beam pairs. For example, the BS 406 in FIG. 4 may receive a transmission 424, from the BS 404, an indication of the measured 422 interference level of each Rx beam 412 in the plurality of Tx-Rx beam pairs between the BS 404 and the BS 406. Alternatively, the BS 406 in FIG. 4 may receive a transmission 424, from the BS 404, a second indication of the measured 422 interference level of each Tx beam 414 in the plurality of Tx-Rx beam pairs between the BS 404 and the BS 406. Further, 1708 may be performed by the probability interface component 198 in FIG. 18 or the probability interface component 199 in FIG. 19.

At 1710, a second wireless device may adjust a beam schedule for at least one of the plurality of Tx-Rx beam pairs based on the received first indication. For example, the BS 406 in FIG. 4 may adjust 454 a beam schedule for the plurality of Tx-Rx beam pairs based on the transmitted 424 measurement of the measured 422 interference level of each Rx beam 412 in the plurality of Tx-Rx beam pairs between the BS 404 and the BS 406. Alternatively, the BS 406 in FIG. 4 may adjust 454 a beam schedule for the plurality of Tx-Rx beam pairs based on the transmitted 424 measurement of the measured 422 interference level of each Tx beam 414 in the plurality of Tx-Rx beam pairs between the BS 404 and the BS 406. Further, 1710 may be performed by the probability interface component 198 in FIG. 18 or the probability interface component 199 in FIG. 19.

In some aspects, the interference level for each of the plurality of Tx-Rx beam pairs may be based on inter-node CLI. For example, the measured 422 interference level in FIG. 4 for each of the plurality of Tx-Rx beam pairs between the BS 404 and the BS 406 may be based on inter-node CLI.

In some aspects, the usage probability corresponds to a first probability over a first time window and the interference probability may correspond to a second probability over a second time window. For example, the identified 434 usage probability in FIG. 4 may correspond to a first probability over a first time window, and the identified 534 interference probability in FIG. 5 may correspond to a second probability over a second time window.

In some aspects, the usage probability may be associated with a usage threshold, and the interference probability is associated with an interference threshold. For example, the identified 434 usage probability in FIG. 4 may be associated with a usage threshold, and the identified 534 interference probability in FIG. 5 may be associated with an interference threshold.

In some aspects, the first indication of the at least one of the usage probability or the interference probability of each Rx beam in the plurality of Tx-Rx beam pairs may be associated with at least one of the usage probability being greater than the usage threshold or the interference level being greater than the interference threshold. For example, the identified 434 usage probability in FIG. 4 of each Tx beam 414 in the plurality of Tx-Rx beam pairs between BS 404 and BS 406 may be associated with the identified 434 usage probability being greater than the usage threshold. Alternatively, the identified 534 interference probability in FIG. 5 of each Tx beam 514 in the plurality of Tx-Rx beam pairs between BS 504 and BS 506 may be associated with the identified 534 usage probability being greater than the usage threshold.

In some aspects, the first wireless device is a first BS or a first UE and the second wireless device may be a second BS or a second UE. For example, BS 404 in FIG. 4 is a BS, UE 802 in FIG. 8 is a UE, BS 406 in FIG. 4 is a BS, and UE 808 in FIG. 8 is a UE.

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include a cellular baseband processor 1824 (also referred to as a modem) coupled to one or more transceivers 1822 (e.g., cellular RF transceiver). The cellular baseband processor 1824 may include on-chip memory 1824′. In some aspects, the apparatus 1804 may further include one or more subscriber identity modules (SIM) cards 1820 and an application processor 1806 coupled to a secure digital (SD) card 1808 and a screen 1810. The application processor 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRx) (or in some cases, just a receiver (Rx)). The Bluetooth module 1812, the WLAN module 1814, and the SPS module 1816 may include their own dedicated antennas and/or utilize the antennas 1880 for communication. The cellular baseband processor 1824 communicates through the transceiver(s) 1822 via one or more antennas 1880 with the UE 104 and/or with an RU associated with a network entity 1802. The cellular baseband processor 1824 and the application processor 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor 1824 and the application processor 1806 are each responsible for general processing, including the execution of software stored on the computer-readable medium/memory. The software, when executed by the cellular baseband processor 1824/application processor 1806, causes the cellular baseband processor 1824/application processor 1806 to perform the various functions described supra. The computer-readable medium/memory may also be used for storing data that is manipulated by the cellular baseband processor 1824/application processor 1806 when executing software. The cellular baseband processor 1824/application processor 1806 may be a component of the UE 350 and may include the memory 360 and/or at least one of the Tx processor 368, the Rx processor 356, and the controller/processor 359. In one configuration, the apparatus 1804 may be a processor chip (modem and/or application) and include just the cellular baseband processor 1824 and/or the application processor 1806, and in another configuration, the apparatus 1804 may be the entire UE (e.g., see UE 350 of FIG. 3) and include the additional modules of the apparatus 1804.

As discussed supra, the component 198 of a first network node may be configured to identify at least one of a usage probability or an interference probability of each Rx beam of the first network node in a plurality of Tx-Rx beam pairs associated with the first network node and the second network node. The usage probability may include a usage metric that indicates a likelihood of using a beam. The interference probability may include an interference metric that indicates a likelihood of a Tx beam of the second network node interfering with an Rx beam of the first network node. The component 198 may also be configured to transmit a first indication of the usage probability or the interference probability of each Rx beam in the plurality of Tx-Rx beam pairs. The second network node may receive the first indication and adjust a beam schedule for at least one of the plurality of Tx-Rx beam pairs based on the received first indication. The component 198 may be within the cellular baseband processor 1824, the application processor 1806, or both the cellular baseband processor 1824 and the application processor 1806. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1804 may include a variety of components configured for various functions. In one configuration, the apparatus 1804, and in particular the cellular baseband processor 1824 and/or the application processor 1806, includes means for measuring an interference level of a Rx beam of the first wireless device or an interference level of a Tx beam of a second wireless device for each of a plurality of Tx-Rx beam pairs associated with the first wireless device and the second wireless device; means for identifying at least one of a usage probability or an interference probability of each Rx beam of the first wireless device in the plurality of Tx-Rx beam pairs; means for transmitting, to the second wireless device, a first indication of at least one of the usage probability or the interference probability of each Rx beam in the plurality of Tx-Rx beam pairs or a second indication of the measured interference level of each Rx beam in the plurality of Tx-Rx beam pairs or the measured interference level of each Tx beam in the plurality of Tx-Rx beam pairs; means for receiving, from a first wireless device, a first indication of at least one of a usage probability or an interference probability of each Rx beam of the first wireless device in a plurality of Tx-Rx beam pairs or a second indication of a measured interference level of each Rx beam in the plurality of Tx-Rx beam pairs or a measured interference level of each Tx beam of the second wireless device in the plurality of Tx-Rx beam pairs; means for adjusting a beam schedule for at least one of the plurality of Tx-Rx beam pairs based on the received first indication or the received second indication; means for receiving, from the second wireless device, a plurality of measurement RSs associated with the plurality of Tx-Rx beam pairs, where at least one of the measured interference levels for each of the plurality of Tx-Rx beam pairs is based on the plurality of measurement RSs; means for receiving, from the second wireless device, an indication of at least one of the usage probability or the interference probability of each Tx beam in the plurality of Tx-Rx beam pairs, where the second indication of the measured interference level of each Tx beam is associated with the received indication of the at least one of the usage probability or the interference probability of each Tx beam in the plurality of Tx-Rx beam pairs; means for receiving, from the second wireless device, a beam schedule for at least one of the plurality of Tx-Rx beam pairs; means for reducing the usage probability of at least one Rx beam associated with at least one of the plurality of Tx-Rx beam pairs based on the beam schedule; means for transmitting, to the second wireless device, a third indication to reduce the usage probability of at least one Tx beam associated with at least one of the plurality of Tx-Rx beam pairs based on the beam schedule; means for transmitting, to the first wireless device, a plurality of measurement reference signals (RSs) associated with the plurality of Tx-Rx beam pairs, where the second indication of the measured interference level of each Rx beam or each Tx beam of the plurality of Tx-Rx beam pairs is based on the plurality of measurement RSs; means for transmitting, to the first wireless device, an indication of at least one of the usage probability or the interference probability of each Tx beam in the plurality of Tx-Rx beam pairs, where the second indication of the measured interference level of each Tx beam is associated with the transmitted indication of at least one of the usage probability or the interference probability of each Tx beam in the plurality of Tx-Rx beam pairs; means for identifying at least one of a usage probability or an interference probability of each Rx beam of the first network node in a plurality of Tx-Rx beam pairs associated with the first network node and a second network node; means for transmitting, to the second network node, a first indication of at least one of the usage probability or the interference probability of each Rx beam in the plurality of Tx-Rx beam pairs; means for receiving, from the second network node, a plurality of measurement RSs associated with the plurality of Tx-Rx beam pairs; means for measuring an interference level of each Rx beam of the first network node in the plurality of Tx-Rx beam pairs or an interference level of each Tx beam of the second network node in the plurality of Tx-Rx beam pairs; means for transmitting, to the second network node, a second indication of the measured interference level of each Rx beam in the plurality of Tx-Rx beam pairs or the measured interference level of each Tx beam in the plurality of Tx-Rx beam pairs; means for receiving, from the second network node, an indication of at least one of the usage probability or the interference probability of each Tx beam in the plurality of Tx-Rx beam pairs; means for receiving, from the second network node, a beam schedule for at least one of the plurality of Tx-Rx beam pairs; means for reducing the usage probability of the at least one Rx beam associated with at least one of the plurality of Tx-Rx beam pairs based on the beam schedule; means for receiving, from the second network node, a beam schedule for at least one of the plurality of Tx-Rx beam pairs; and means for transmitting, to the second network node, a third indication to reduce the usage probability of the at least one Tx beam associated with the plurality of Tx-Rx beam pairs based on the beam schedule. The means may be the component 198 of the apparatus 1804 configured to perform the functions recited by the means. As described supra, the apparatus 1804 may include the Tx processor 368, the Rx processor 356, and the controller/processor 359. As such, in one configuration, the means may be the Tx processor 368, the Rx processor 356, and/or the controller/processor 359 configured to perform the functions recited by the means.

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include a CU processor 1912. The CU processor 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include a DU processor 1932. The DU processor 1932 may include on-chip memory 1932′. In some aspects, the DU 1930 may further include additional memory modules 1934 and a communications interface 1938. The DU 1930 communicates with the RU 1940 through a fronthaul link. The RU 1940 may include an RU processor 1942. The RU processor 1942 may include on-chip memory 1942′. In some aspects, the RU 1940 may further include additional memory modules 1944, one or more transceivers 1946, antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 at a first network node may be configured to receive, from a second network node, a first indication of at least one of a usage probability or an interference probability of each Rx beam of the second network node in a plurality of Tx-Rx beam pairs. The usage probability may include a usage metric that indicates a likelihood of using a beam. The interference probability may include an interference metric that indicates a likelihood of a Tx beam of the first network node interfering with an Rx beam of the second network node. The component 199 may further be configured to adjust a beam schedule for at least one of the plurality of Tx-Rx beam pairs based on the received first indication. The component 199 may be within one or more processors of one or more of the CU 1910, DU 1930, and the RU 1940. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1902 may include a variety of components configured for various functions. In one configuration, the network entity 1902 includes means for measuring an interference level of a Rx beam of the first wireless device or an interference level of a Tx beam of a second wireless device for each of a plurality of Tx-Rx beam pairs associated with the first wireless device and the second wireless device; means for identifying at least one of a usage probability or an interference probability of each Rx beam of the first wireless device in the plurality of Tx-Rx beam pairs; means for transmitting, to the second wireless device, a first indication of at least one of the usage probability or the interference probability of each Rx beam in the plurality of Tx-Rx beam pairs or a second indication of the measured interference level of each Rx beam in the plurality of Tx-Rx beam pairs or the measured interference level of each Tx beam in the plurality of Tx-Rx beam pairs; means for receiving, from a first wireless device, a first indication of at least one of a usage probability or an interference probability of each Rx beam of the first wireless device in a plurality of Tx-Rx beam pairs or a second indication of a measured interference level of each Rx beam in the plurality of Tx-Rx beam pairs or a measured interference level of each Tx beam of the second wireless device in the plurality of Tx-Rx beam pairs; means for adjusting a beam schedule for at least one of the plurality of Tx-Rx beam pairs based on the received first indication or the received second indication; means for receiving, from the second wireless device, a plurality of measurement RSs associated with the plurality of Tx-Rx beam pairs, where at least one of the measured interference levels for each of the plurality of Tx-Rx beam pairs is based on the plurality of measurement RSs; means for receiving, from the second wireless device, an indication of at least one of the usage probability or the interference probability of each Tx beam in the plurality of Tx-Rx beam pairs, where the second indication of the measured interference level of each Tx beam is associated with the received indication of the at least one of the usage probability or the interference probability of each Tx beam in the plurality of Tx-Rx beam pairs; means for receiving, from the second wireless device, a beam schedule for at least one of the plurality of Tx-Rx beam pairs; means for reducing the usage probability of at least one Rx beam associated with at least one of the plurality of Tx-Rx beam pairs based on the beam schedule; means for transmitting, to the second wireless device, a third indication to reduce the usage probability of at least one Tx beam associated with at least one of the plurality of Tx-Rx beam pairs based on the beam schedule; means for transmitting, to the first wireless device, a plurality of measurement reference signals (RSs) associated with the plurality of Tx-Rx beam pairs, where the second indication of the measured interference level of each Rx beam or each Tx beam of the plurality of Tx-Rx beam pairs is based on the plurality of measurement RSs; means for transmitting, to the first wireless device, an indication of at least one of the usage probability or the interference probability of each Tx beam in the plurality of Tx-Rx beam pairs, where the second indication of the measured interference level of each Tx beam is associated with the transmitted indication of at least one of the usage probability or the interference probability of each Tx beam in the plurality of Tx-Rx beam pairs; means for receiving, from a second network node, a first indication of at least one of a usage probability or an interference probability of each Rx beam of the second network node in a plurality of Tx-Rx beam pairs; means for adjusting a beam schedule for at least one of the plurality of Tx-Rx beam pairs based on the received first indication; means for transmitting, to the second network node, a plurality of measurement RSs associated with the plurality of Tx-Rx beam pairs; means for receiving, from the second network node, a second indication of a measured interference level of each Rx beam in the plurality of Tx-Rx beam pairs or a measured interference level of each Tx beam of the first network node in the plurality of Tx-Rx beam pairs; means for adjusting the beam schedule for the at least one of the plurality of Tx-Rx beam pairs based on the second indication; and means for transmitting, to the second network node, an indication of at least one of the usage probability or the interference probability of each Tx beam in the plurality of Tx-Rx beam pairs. The means may be the component 199 of the network entity 1902 configured to perform the functions recited by the means. As described supra, the network entity 1902 may include the Tx processor 316, the Rx processor 370, and the controller/processor 375. As such, in one configuration, the means may be the Tx processor 316, the Rx processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a network node, including identifying at least one of a usage probability or an interference probability of each Rx beam of the first network node in a plurality of Tx-Rx beam pairs associated with the first network node and a second network node. The usage probability may include a usage metric that indicates a likelihood of using a beam. The interference probability may include an interference metric that indicates a likelihood of a Tx beam of the second network node interfering with an Rx beam of the first network node. The method may further include transmitting, to the second network node, a first indication of at least one of the usage probability or the interference probability of each Rx beam in the plurality of Tx-Rx beam pairs.

Aspect 2 is the method of aspect 1, where the method may further include receiving, from the second network node, a plurality of measurement RSs associated with the plurality of Tx-Rx beam pairs. The method may further include measuring an interference level of each Rx beam of the first network node in the plurality of Tx-Rx beam pairs or an interference level of each Tx beam of the second network node in the plurality of Tx-Rx beam pairs. At least one of the measured interference levels for each of the plurality of Tx-Rx beam pairs may be based on the plurality of measurement RSs. The method may further include transmitting, to the second network node, a second indication of the measured interference level of each Rx beam in the plurality of Tx-Rx beam pairs or the measured interference level of each Tx beam in the plurality of Tx-Rx beam pairs.

Aspect 3 is the method of aspect 2, where the method may further include receiving, from the second network node, an indication of at least one of the usage probability or the interference probability of each Tx beam in the plurality of Tx-Rx beam pairs. The second indication of the measured interference level of each Tx beam may be associated with the received first indication of the at least one of the usage probability or the interference probability of each Tx beam in the plurality of Tx-Rx beam pairs.

Aspect 4 is the method of any of aspects 2 and 3, where the interference level for each of the plurality of Tx-Rx beam pairs may be based on inter-node CLI.

Aspect 5 is the method of any of aspects 1 to 4, where the usage probability may correspond to a first probability over a first time window. The interference probability may correspond to a second probability over a second time window.

Aspect 6 is the method of any of aspects 1 to 5, where the usage probability may be associated with a usage threshold. The interference probability may be associated with an interference threshold.

Aspect 7 is the method of any of aspect 6, where the first indication of the at least one of the usage probability or the interference probability of each Rx beam in the plurality of Tx-Rx beam pairs may be associated with at least one of the usage probability being greater than the usage threshold or an interference level being greater than the interference threshold.

Aspect 8 is the method of any of aspects 1 to 7, where the first network node may be a first BS or a first UE. The second network node may be a second BS or a second UE.

Aspect 9 is the method of aspect 8, where the first network node may be the first UE. The second network node may be the second BS. The first network node may be configured to operate in a network in which the second network node is configured to transmit at least one usage probability via inter-BS messaging to a third BS configured to serve the first network node. The usage probability may indicate a first likelihood for the second network node to transmit at least one Tx beam that interferes with at least one Rx beam of the plurality of Tx-Rx beam pairs.

Aspect 10 is the method of aspect 8, where the first network node may be the first BS. The second network node may be the second UE. The first network node may be configured to operate in a network in which the second network node is configured to transmit at least one usage probability to a third BS configured to serve the second network node. The usage probability may indicate a first likelihood for the second network node to transmit at least one Tx beam that interferes with at least one Rx beam of the plurality of Tx-Rx beam pairs.

Aspect 11 is the method of aspect 8, where the first network node may be the first UE. The second network node may be the second UE. The first indication may include a first usage probability for the second network node to transmit at least one SL Tx beam that interferes with a SL Rx beam of the plurality of Tx-Rx beam pairs.

Aspect 12 is the method of aspect 8, where the first network node may be the first UE and the network node device may be the second UE. The first network node may be configured to operate in a network in which the second network node is configured to transmit at least one usage probability to a third BS configured to serve the second network node. The usage probability may indicate a first likelihood for the second network node to transmit at least one Tx beam that interferes with at least one Rx beam of the plurality of Tx-Rx beam pairs.

Aspect 13 is the method of aspect 8, where the first network node is the first BS and the second network node is the second BS. The method may further include, to transmit the first indication, transmitting the first indication of the usage probability to the second network node. The usage probability may indicate a first likelihood for the second network node to transmit at least one Tx beam that interferes with at least one Rx beam of the plurality of Tx-Rx beam pairs.

Aspect 14 is the method of any of aspects 1 to 13, where the method may further include receiving, from the second network node, a beam schedule for at least one of the plurality of Tx-Rx beam pairs. The beam schedule may include an increased usage probability for the second network node to use a Tx beam associated with the plurality of Tx-Rx beam pairs that interferes with at least one Rx beam associated with at least one of the plurality of Tx-Rx beam pairs. The method may further include reducing the usage probability of the at least one Rx beam associated with at least one of the plurality of Tx-Rx beam pairs based on the beam schedule.

Aspect 15 is the method of any of aspects 1 to 14, where the method may further include receiving, from the second network node, a beam schedule for at least one of the plurality of Tx-Rx beam pairs. The beam schedule may include an increased usage probability for the second network node to use at least one Tx beam associated with the plurality of Tx-Rx beam pairs that interferes with at least one Rx beam associated with the plurality of Tx-Rx beam pairs. The method may further include transmitting, to the second network node, a third indication to reduce the usage probability of the at least one Tx beam associated with the plurality of Tx-Rx beam pairs based on the beam schedule.

Aspect 16 is a method of wireless communication at a first network node, including receiving, from a second network node, a first indication of at least one of a usage probability or an interference probability of each Rx beam of the second network node in a plurality of Tx-Rx beam pairs. The usage probability may include a usage metric that indicates a likelihood of using a beam. The interference probability may include an interference metric that indicates a likelihood of a Tx beam of the first network node interfering with an Rx beam of the second network node. The method may further include adjusting a beam schedule for at least one of the plurality of Tx-Rx beam pairs based on the received first indication.

Aspect 17 is the method of aspect 16, where the method may further include transmitting, to the second network node, a plurality of measurement RSs associated with the plurality of Tx-Rx beam pairs. The method may further include receiving, from the second network node, a second indication of a measured interference level of each Rx beam in the plurality of Tx-Rx beam pairs or a measured interference level of each Tx beam of the first network node in the plurality of Tx-Rx beam pairs. The method may further include, to adjust the beam schedule for the at least one of the plurality of Tx-Rx beam pairs, adjusting the beam schedule for the at least one of the plurality of Tx-Rx beam pairs based on the second indication. The second indication of the measured interference level of each Rx beam or each Tx beam of the plurality of Tx-Rx beam pairs may be based on the plurality of measurement RSs.

Aspect 18 is the method of aspect 17, where the method may further include transmitting, to the second network node, an indication of at least one of the usage probability or the interference probability of each Tx beam in the plurality of Tx-Rx beam pairs. The second indication of the measured interference level of each Tx beam may be associated with the transmitted first indication of at least one of the usage probability or the interference probability of each Tx beam in the plurality of Tx-Rx beam pairs.

Aspect 19 is the method of aspect 17, where the interference level for each of the plurality of Tx-Rx beam pairs may be based on inter-node CLI.

Aspect 20 is the method of any of aspects 16 to 19, where the usage probability may correspond to a first probability over a first time window. The interference probability may correspond to a second probability over a second time window.

Aspect 21 is the method of any of aspects 16 to 20, where the usage probability may be associated with a usage threshold, and the interference probability is associated with an interference threshold.

Aspect 22 is the method of aspect 21, where the first indication of the at least one of the usage probability or the interference probability of each Rx beam in the plurality of Tx-Rx beam pairs may be associated with at least one of the usage probability being greater than the usage threshold or the interference probability being greater than the interference threshold.

Aspect 23 is the method of any of aspects 16 to 22, where the second network node may be a first BS or a first UE. The first network node may be a second BS or a second UE.

Aspect 24 is the method of any of aspects 16 to 23, where the beam schedule may correspond to a first beam schedule for the second network node or a second beam schedule for the first network node.

Aspect 25 is the method of any of aspects 16 to 24, where the method may further include, to adjust the beam schedule for at least one of the plurality of Tx-Rx beam pairs, adjusting the usage probability of the Rx beam or the Tx beam for at least one of the plurality of Tx-Rx beam pairs.

Aspect 26 is an apparatus for wireless communication at a network node, including: a memory; and at least one processor coupled to the memory and, based at least in part on information stored in the memory, the at least one processor is configured to implement any of aspects 1 to 25.

Aspect 27 is the apparatus of aspect 26, further including at least one of an antenna or a transceiver coupled to the at least one processor.

Aspect 28 is an apparatus for wireless communication including means for implementing any of aspects 1 to 25.

Aspect 29 is a computer-readable medium (e.g., a non-transitory computer-readable medium) storing computer executable code, where the code when executed by a processor causes the processor to implement any of aspects 1 to 25.

What is claimed is:

1. A first network node for wireless communication, comprising:
a memory; and
at least one processor coupled to the memory, wherein the at least one processor is configured to:
identify at least one of a usage probability or an interference probability of each receive (Rx) beam of the first network node in a plurality of transmit (Tx)-Rx beam pairs associated with the first network node and a second network node, wherein the usage probability comprises a usage metric that indicates a likelihood of using a beam and the interference probability comprises an interference metric that indicates a likelihood of a Tx beam of the second network node interfering with an Rx beam of the first network node; and
transmit, to the second network node, a first indication of at least one of the usage probability or the interference probability of each Rx beam in the plurality of Tx-Rx beam pairs.

2. The first network node of claim 1, wherein the at least one processor is further configured to:
receive, from the second network node, a plurality of measurement reference signals (RSs) associated with the plurality of Tx-Rx beam pairs;
measure an interference level of each Rx beam of the first network node in the plurality of Tx-Rx beam pairs or an interference level of each Tx beam of the second network node in the plurality of Tx-Rx beam pairs, wherein at least one of the measured interference levels for each of the plurality of Tx-Rx beam pairs is based on the plurality of measurement RSs; and
transmit, to the second network node, a second indication of the measured interference level of each Rx beam in the plurality of Tx-Rx beam pairs or the measured interference level of each Tx beam in the plurality of Tx-Rx beam pairs.

3. The first network node of claim 2, wherein the at least one processor is further configured to receive, from the second network node, an indication of at least one of the usage probability or the interference probability of each Tx beam in the plurality of Tx-Rx beam pairs, wherein the second indication of the measured interference level of each Tx beam is associated with the received first indication of the at least one of the usage probability or the interference probability of each Tx beam in the plurality of Tx-Rx beam pairs.

4. The first network node of claim 2, wherein the interference level for each of the plurality of Tx-Rx beam pairs is based on inter-node cross link interference (CLI).

5. The first network node of claim 1, wherein the usage probability corresponds to a first probability over a first time window, and the interference probability corresponds to a second probability over a second time window.

6. The first network node of claim 1, wherein the usage probability is associated with a usage threshold, and the interference probability is associated with an interference threshold.

7. The first network node of claim 6, wherein the first indication of the at least one of the usage probability or the interference probability of each Rx beam in the plurality of Tx-Rx beam pairs is associated with at least one of the usage probability being greater than the usage threshold or an interference level being greater than the interference threshold.

8. The first network node of claim 1, further comprising a transceiver coupled to the at least one processor, wherein the first network node is a first base station (BS) or a first user equipment (UE) and the second network node is a second BS or a second UE.

9. The first network node of claim 8,
wherein the first network node is the first UE;
wherein the second network node is the second BS; and
wherein the first network node is configured to operate in a network in which the second network node is configured to transmit at least one usage probability via inter-BS messaging to a third BS configured to serve the first network node, wherein the usage probability indicates a first likelihood for the second network node to transmit at least one Tx beam that interferes with at least one Rx beam of the plurality of Tx-Rx beam pairs.

10. The first network node of claim 8,
wherein the first network node is the first BS;
wherein the second network node is the second UE; and
wherein the first network node is configured to operate in a network in which the second network node is configured to transmit at least one usage probability to a third BS configured to serve the second network node, wherein the usage probability indicates a first likelihood for the second network node to transmit at least one Tx beam that interferes with at least one Rx beam of the plurality of Tx-Rx beam pairs.

11. The first network node of claim 8,
wherein the first network node is the first UE;
wherein the second network node is the second UE; and
wherein the first indication comprises a first usage probability for the second network node to transmit at least one sidelink (SL) Tx beam that interferes with a SL Rx beam of the plurality of Tx-Rx beam pairs.

12. The first network node of claim 8,
wherein the first network node is the first UE;
wherein the second network node is the second UE; and
wherein the first network node is configured to operate in a network in which the second network node is configured to transmit at least one usage probability to a third BS configured to serve the second network node, wherein the usage probability indicates a first likelihood for the second network node to transmit at least one Tx beam that interferes with at least one Rx beam of the plurality of Tx-Rx beam pairs.

13. The first network node of claim 8,
wherein the first network node is the first BS;
wherein the second network node is the second BS; and
wherein, to transmit the first indication, the at least one processor is configured to transmit the first indication of the usage probability to the second network node, wherein the usage probability indicates a first likelihood for the second network node to transmit at least one Tx beam that interferes with at least one Rx beam of the plurality of Tx-Rx beam pairs.

14. The first network node of claim 1, wherein the at least one processor is further configured to:
receive, from the second network node, a beam schedule for at least one of the plurality of Tx-Rx beam pairs, wherein the beam schedule comprises an increased usage probability for the second network node to use a Tx beam associated with the plurality of Tx-Rx beam pairs that interferes with at least one Rx beam associated with at least one of the plurality of Tx-Rx beam pairs; and
reduce the usage probability of the at least one Rx beam associated with at least one of the plurality of Tx-Rx beam pairs based on the beam schedule.

15. The first network node of claim 1, wherein the at least one processor is further configured to:
receive, from the second network node, a beam schedule for at least one of the plurality of Tx-Rx beam pairs, wherein the beam schedule comprises an increased usage probability for the second network node to use at least one Tx beam associated with the plurality of Tx-Rx beam pairs that interferes with at least one Rx beam associated with the plurality of Tx-Rx beam pairs; and
transmit, to the second network node, a third indication to reduce the usage probability of the at least one Tx beam associated with the plurality of Tx-Rx beam pairs based on the beam schedule.

16. A first network node for wireless communication, comprising:
a memory; and
at least one processor coupled to the memory, wherein the at least one processor is configured to:
receive, from a second network node, a first indication of at least one of a usage probability or an interference probability of each receive (Rx) beam of the second network node in a plurality of transmit (Tx)-Rx beam pairs, wherein the usage probability comprises a usage metric that indicates a likelihood of using a beam and the interference probability comprises an interference metric that indicates a likelihood of a Tx beam of the first network node interfering with an Rx beam of the second network node; and
adjust a beam schedule for at least one of the plurality of Tx-Rx beam pairs based on the received first indication.

17. The first network node of claim 16, wherein the at least one processor is further configured to:
transmit, to the second network node, a plurality of measurement reference signals (RSs) associated with the plurality of Tx-Rx beam pairs; and
receive, from the second network node, a second indication of a measured interference level of each Rx beam in the plurality of Tx-Rx beam pairs or a measured interference level of each Tx beam of the first network node in the plurality of Tx-Rx beam pairs, wherein to adjust the beam schedule for the at least one of the plurality of Tx-Rx beam pairs, the at least one processor is configured to adjust the beam schedule for the at least one of the plurality of Tx-Rx beam pairs based on the second indication, wherein the second indication of the measured interference level of each Rx beam or each Tx beam of the plurality of Tx-Rx beam pairs is based on the plurality of measurement RSs.

18. The first network node of claim 17, wherein the at least one processor is further configured to transmit, to the second network node, an indication of at least one of the usage probability or the interference probability of each Tx beam in the plurality of Tx-Rx beam pairs, wherein the second indication of the measured interference level of each Tx beam is associated with the transmitted first indication of at least one of the usage probability or the interference probability of each Tx beam in the plurality of Tx-Rx beam pairs.

19. The first network node of claim 17, wherein the interference level for each of the plurality of Tx-Rx beam pairs is based on inter-node cross link interference (CLI).

20. The first network node of claim 16, wherein the usage probability corresponds to a first probability over a first time window and the interference probability corresponds to a second probability over a second time window.

21. The first network node of claim 16, further comprising a transceiver coupled to the at least one processor, wherein the usage probability is associated with a usage threshold, and the interference probability is associated with an interference threshold.

22. The first network node of claim 21, wherein the first indication of the at least one of the usage probability or the interference probability of each Rx beam in the plurality of Tx-Rx beam pairs is associated with at least one of the usage probability being greater than the usage threshold or the interference probability being greater than the interference threshold.

23. The first network node of claim 16, wherein the second network node is a first base station (BS) or a first user equipment (UE) and the first network node is a second BS or a second UE.

24. The first network node of claim 16, wherein the beam schedule corresponds to a first beam schedule for the second network node or a second beam schedule for the first network node.

25. The first network node of claim 16, wherein to adjust the beam schedule for at least one of the plurality of Tx-Rx beam pairs, the at least one processor is configured to adjust the usage probability of the Rx beam or the Tx beam for at least one of the plurality of Tx-Rx beam pairs.

26. A method of wireless communication performed by a first network node, comprising:
identifying at least one of a usage probability or an interference probability of each receive (Rx) beam of the first network node in a plurality of transmit (Tx)-Rx beam pairs associated with the first network node and a second network node, wherein the usage probability comprises a usage metric that indicates a likelihood of using a beam and the interference probability comprises an interference metric that indicates a likelihood of a Tx beam of the second network node interfering with an Rx beam of the first network node; and
transmitting, to the second network node, a first indication of at least one of the usage probability or the interference probability of each Rx beam in the plurality of Tx-Rx beam pairs.

27. The method of claim 26, further comprising:
measuring an interference level of each Rx beam of the first network node in the plurality of Tx-Rx beam pairs or an interference level of each Tx beam of the second network node in the plurality of Tx-Rx beam pairs;
receiving, from the second network node, an indication of at least one of the usage probability or the interference probability of each Tx beam in the plurality of Tx-Rx beam pairs; and
transmitting, to the second network node, a second indication of the measured interference level of each Rx beam in the plurality of Tx-Rx beam pairs or the measured interference level of each Tx beam in the plurality of Tx-Rx beam pairs, wherein the second indication of the measured interference level of each Tx beam is associated with the received indication of the at least one of the usage probability or the interference probability of each Tx beam in the plurality of Tx-Rx beam pairs.

28. The method of claim 26, further comprising:
receiving, from the second network node, a beam schedule for at least one of the plurality of Tx-Rx beam pairs, wherein the beam schedule comprises an increased usage probability for the second network node to use a Tx beam associated with the plurality of Tx-Rx beam pairs that interferes with at least one Rx beam associated with at least one of the plurality of Tx-Rx beam pairs; and
reducing the usage probability of the at least one Rx beam associated with at least one of the plurality of Tx-Rx beam pairs based on the beam schedule.

29. A method of wireless communication performed by a first network node, comprising:
receiving, from a second network node, a first indication of at least one of a usage probability or an interference probability of each receive (Rx) beam of the second network node in a plurality of transmit (Tx)-Rx beam pairs, wherein the usage probability comprises a usage metric that indicates a likelihood of using a beam and the interference probability comprises an interference metric that indicates a likelihood of a Tx beam of the first network node interfering with an Rx beam of the second network node; and
adjusting a beam schedule for at least one of the plurality of Tx-Rx beam pairs based on the received first indication.

30. The method of claim 29, further comprising:
transmitting, to the second network node, a plurality of measurement reference signals (RSs) associated with the plurality of Tx-Rx beam pairs; and
receiving, from the second network node, a second indication of a measured interference level of each Rx beam in the plurality of Tx-Rx beam pairs or a measured interference level of each Tx beam of the first network node in the plurality of Tx-Rx beam pairs, wherein adjusting the beam schedule for the at least one of the plurality of Tx-Rx beam pairs comprises adjusting the beam schedule for the at least one of the plurality of Tx-Rx beam pairs based on the received second indication, wherein the second indication of the measured interference level of each Rx beam or each Tx beam of the plurality of Tx-Rx beam pairs is based on the plurality of measurement RSs.
